(19) United States
(12) Patent Application Publication
(10) Pub. No.: US 2026/0095786 A1
(43) Pub. Date: Apr. 2, 2026

(54) Reduced Capacity Application Service-Based Intelligent Power Saving with Machine Learning

(71) Applicant: Apple Inc., Cupertino, CA (US)

(72) Inventors: Han Pu, Shanghai (CN); Dongzhou Yang, Beijing (CN); Alosious Pradeep Prabhakar, Singapore (SG); Lijie Zhang, Beijing (CN)

(21) Appl. No.: 18/900,535

(22) Filed: Sep. 27, 2024

(51) Int. Cl. H04W 24/08; H04W 16/14

(52) U.S. Cl. CPC H04W 24/08; H04W 16/14

(57) ABSTRACT

An apparatus of a reduced capability (RedCap) user equipment (UE) comprises one or more processors coupled to a memory. The processors are configured to detect, at the UE, a service-based scenario of the UE. The service-based scenario includes at least one of a stationary scenario, a fixed route or a normal route. The processors apply, at the UE, a service-based radio frequency (RF) evaluation based on the service-based scenario using a machine learning (ML) model. The processors perform, at the UE, a relaxed radio resource management (RRM) measurement of one or more measurement objects (MOs) based on the service-based RF evaluation determined by the ML model and the service-based scenario.

### FIELD

Embodiments of the invention relate to wireless communications, including apparatuses, systems, and methods for a reduced capacity application service-based intelligent power saving with machine learning in wireless communication systems.

### DESCRIPTION OF THE RELATED ART

Wireless communication systems are used to provide various communication services such as telephone, video, data and messaging. The wireless communication systems can support communication with multiple users by sharing available system resources such as bandwidth and transmit power.

The wireless communication system may include a number of base stations (BSs) that can support communication for a number of user equipment (UEs). A BS may be referred to as a Node B, a gNB, an access point (AP), a radio head, a transmit receive point (TRP), a New Radio (NR) BS, a 5G Node B, or the like. A UE may be referred to as a wireless mobile device or cellular phone.

Telecommunication standards have been adopted to provide a common protocol to enable different UEs and BSs to communicate on a municipal, national, regional, and even global level. Wireless communication system standards and protocols can include the 3rd Generation Partnership Project (3GPP) long term evolution (LTE) (e.g., 4G) or new radio (NR) (e.g., 5G). In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with the UE. In fifth generation (5G) wireless RANs, RAN Nodes can include a 5G Node, or NR node (also referred to as a next generation Node B or g Node B (gNB)).

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates example components of a core network in accordance with some embodiments.

FIG. 9 illustrates an example of an architecture for determining a position of a user equipment in a Legacy wireless system according to some embodiments.

FIG. 10 illustrates an example flow chart for determining a position of a user equipment in a Legacy wireless system according to some embodiments.

FIG. 11 illustrates an example flow chart for determining a position of a user equipment in a wireless system using a direct AI/ML model according to some embodiments.

FIG. 12 illustrates an example flow chart for determining a position of a user equipment in a wireless system using an assisted AI/ML model according to some embodiments.

FIG. 13 illustrates an example of an architecture for determining a position of a user equipment using a direct UE-side model according to some embodiments.

FIG. 14 illustrates an example of an architecture for determining a position of a user equipment using a direct LMF-side model according to some embodiments.

FIG. 15 illustrates an example of an architecture for determining a position of a user equipment using an assisted UE-side model according to some embodiments.

FIG. 16 illustrates an example of an architecture for determining a position of a user equipment using an assisted base station-side model according to some embodiments.

FIG. 17 illustrates a diagram of an example of ML model structure for service based on a scenario, according to some embodiments.

FIGS. 18A-D illustrate flow charts for an example system and method of service-based dynamic relaxed RRM measurement in an idle/inactive mode in a wireless communication system, according to some embodiments.

FIG. 19 illustrates an example flow chart for a method of a relaxed radio resource management (RRM) measurement of an apparatus of a reduced capability (RedCap) user equipment (UE) in a wireless communication system, according to some embodiments.

FIG. 20 illustrates signaling of a relaxed RRM measurement in a connected mode in a wireless communication system, according to some embodiments.

FIG. 21 illustrates signaling of a relaxed RRM measurement in a connected mode in a wireless communication system, according to some embodiments.

FIG. 22 illustrates an example flow chart for a method of a relaxed radio resource management (RRM) measurement of an apparatus of a reduced capability (RedCap) user equipment (UE) in a wireless communication system, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium or Memory—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, Internet of Things, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate with UEs as part of a wireless telephone system or radio system, including but not limited Next Generation Node-Bs (gNB or gNodeB) in NR and NG-RAN nodes.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Legacy—The 3rd Generation Partnership Project (3GPP) produces specifications that define 3GPP technologies. 3GPP specifications cover cellular telecommunications technologies, including radio access, core network and service capabilities, which provide a complete system description for mobile telecommunications. 3GPP uses a system of parallel “Releases” that provide developers with a stable platform for the implementation of features at a given point and then allow for the addition of new functionality in subsequent releases. Release 17 was released in 2022. Release 18 (Rel-18), at the time of this disclosure, is nearing release on Jun. 22, 2024, as its specifications have been largely defined. Accordingly, implementations and concepts compatible with Rel-18, or previous Releases, are sometimes referred to herein as “Legacy Releases.” One or more embodiments of the present disclosure may be adopted in future Releases, e.g., Release 19.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to apparatuses, systems and methods for a reduced capacity (RedCap) application (APP) service-based scenario intelligent power savings using a machine learning (ML) model. An apparatus of a reduced capability user equipment (UE) (e.g. a wearable) can dynamically select a relaxed radio resource management (RRM) measurement based on a service-based scenario (e.g. stationary, fixed route or normal route). In one aspect, when the reduced capability UE is in an idle/inactive mode, the apparatus of the UE can stop RRM measurements or can perform relaxed RRM measurements based on an ML model prediction. In another aspect, when the UE is in a connected mode, the apparatus of the UE can enter a relaxed RRM measurement status based on an ML model, and can signal a radio resource control (RRC) UE assistance information (UAI) with a relaxed RRM indication to a network. In addition, the apparatus of the UE can locally suspend specific measurement objects (MOs) when a network configuration of MOs does not match with MOs determined by the ML inference at the UE.

The example embodiments are described with regard to communication between a base station, e.g. a Next Generation Node B (gNB), and a user equipment (UE). However, reference to a base station (gNB) or a UE is merely provided for illustrative purposes. The example embodiments may be utilized with any electronic component that may establish a connection to a network and is configured with the hardware, software, and/or firmware to support for reducing energy usage by network components in wireless communication systems. Therefore, the gNB or UE as described herein is used to represent any appropriate type of electronic component.

The example embodiments are also described with regard to a fifth generation (5G) New Radio (NR). However, reference to a 5G NR network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

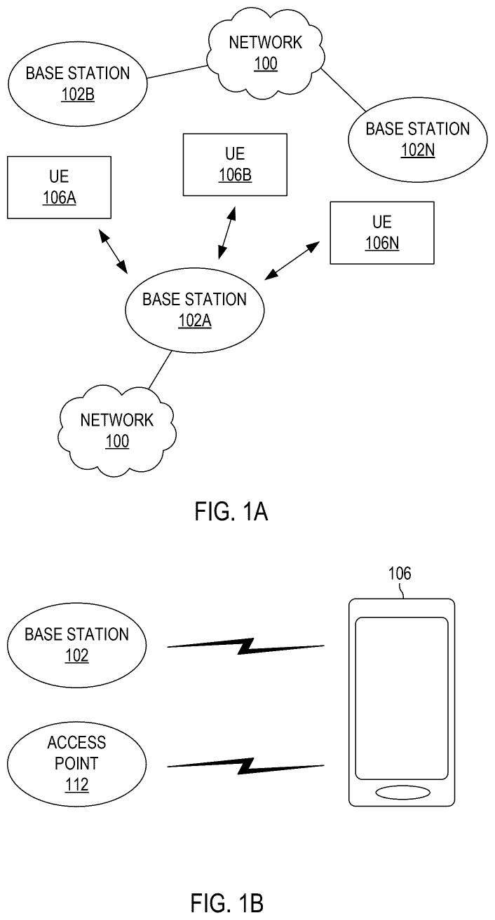

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as long term evolution (LTE), LTE-Advanced (LTE-A), 5G new radio (5G NR), etc. Note that if the base station 102A is implemented in the context of LTE, also referred to as the Evolved Universal Terrestrial Radio Access Network (E-UTRAN), it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network 820 of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., LTE, LTE-A, 5G NR, etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

In some embodiments, the base station 102A may select a paging configuration and a PEI configuration for UEs 106. The base station 102A may encode and transmit the paging configuration and the PEI configuration to UEs 106 as part of a registration process. Using the paging configuration, UEs 106 can determine which PO and PF to monitor in a paging cycle. Using the PEI configuration, UEs 106 can determine the radio frame that carries relevant PEI.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, LTE/LTE-Advanced, or 5G NR using a single shared radio and/or LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

As described herein, a relaxed RRM status message and an RRC reconfiguration message can be signaled between the UE 106 and the NW 100 (or a NR-RAN 810 or the gNB), via the base station 102. The messaging can comprise an RRC UAI message with a relaxed RRM indication generated and encoded at the UE 106 for transmission to and received by and decoded by the base station 102 for the NW 100. An RRC reconfiguration message may also be communicated with removed MOs generated by the NW 100 and encoded at the base station 102 for transmission to and received by and decoded at the UE 106.

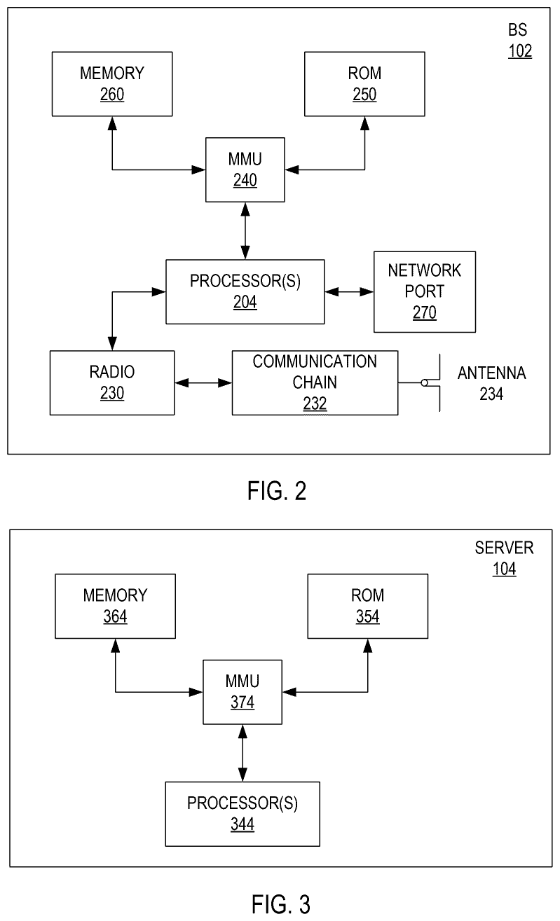

FIG. 2: Block Diagram of a Base Station (gNB)

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE, etc.).

As described further subsequently herein, the base station 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the base station 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

As described herein, the RRC UAI message and/or the RRC reconfiguration message with removed MOs can be signaled between the UE 106 and the NW 100 (or the NR-RAN 810 or the gNB), via the base station 102. The one or more processors 204 of the base station 102 may be used to execute messages (e.g. program instructions) that are received and decoded from the UE 106. In some embodiments, the base station or gNB 102, and/or processors 204 thereof, can be capable of and configured to generate (or encode) the RRC UAI messages for transmission to the UE 106, and receive the relaxed RRM status message from the UE 106.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, and UE devices 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

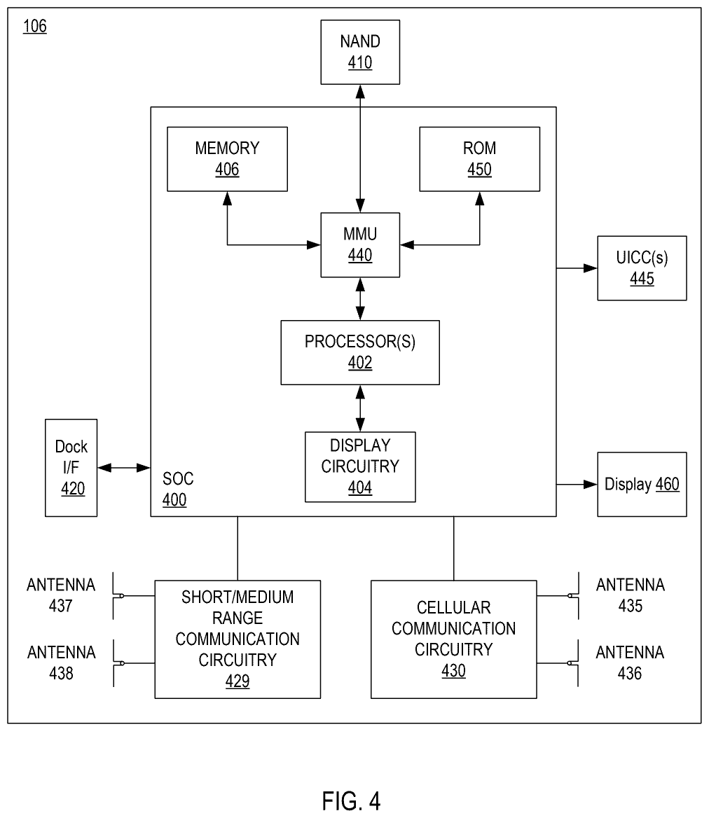

### FIG. 4: Block Diagram of a User Equipment (UE)

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and/or the one or more processors 402 thereof can collect collected data and develop ML models based on the collected data. In addition, in some embodiments, the UE 106 and/or the one or more processors 402 thereof can determine a service-based scenario based on the ML models. Furthermore, in some embodiments, the UE 106 and/or the one or more processors 402 thereof can enter a relaxed RRM status based on the ML models.

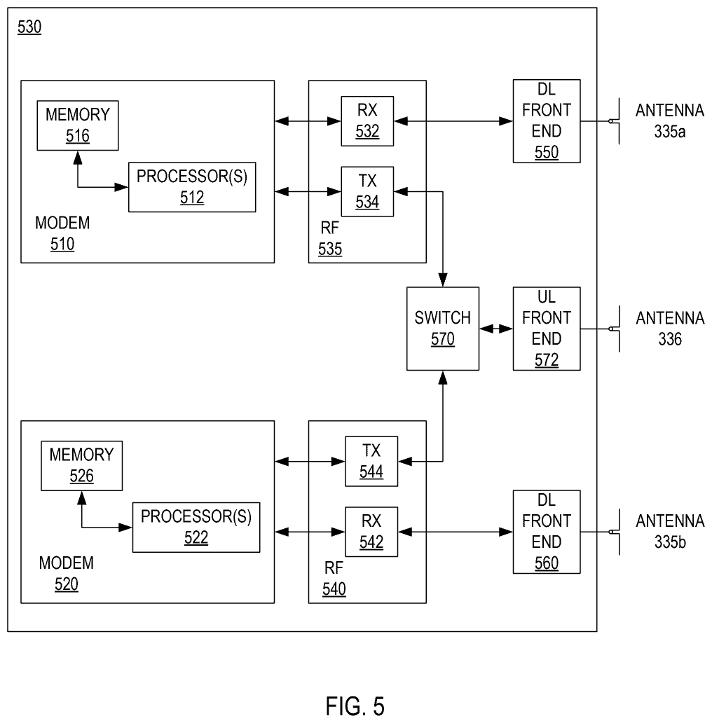

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 535. RF front end 535 may include circuitry for transmitting and receiving radio signals. For example, RF front end 535 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 535, 550, 570, 572, 335a, 335b, and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335a, 335b, and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

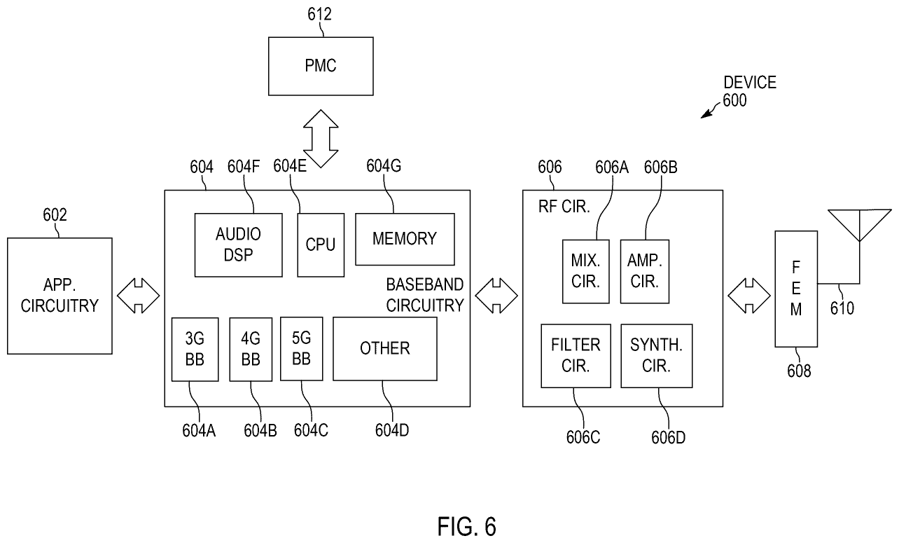

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node 102A. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where, again, it periodically wakes up to listen to the network and then powers down at least portions of the device again. The device 600 may not receive data in this state. In order to receive data, it will transition back to an RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

In some embodiments, the UE 106 and/or the baseband circuitry 604 and one or more processors thereof can apply a service-based radio frequency (RF) evaluation based on the service-based scenario using the ML models, and can perform a relaxed RRM measurement of one or more MOs based on the service-based RF evaluation determined by the ML model and the service-based scenario. In addition, in some embodiments, the UE 106 and/or the baseband circuitry 604 and one or more processors thereof can encode and decode (generate and receive) messages for transmission to and reception from the NW 100 (or NR-RAN 810), encode (generate) an RRC UAI message with a relaxed RRM indication for transmission to the NW 100, and decode (receive) an RRC reconfiguration message with removed MOs from the NW 100.

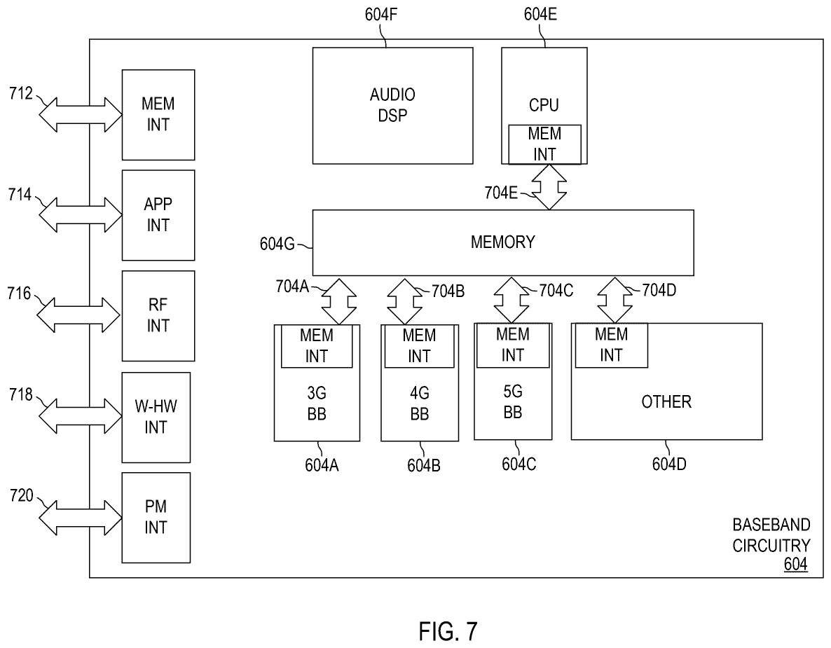

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

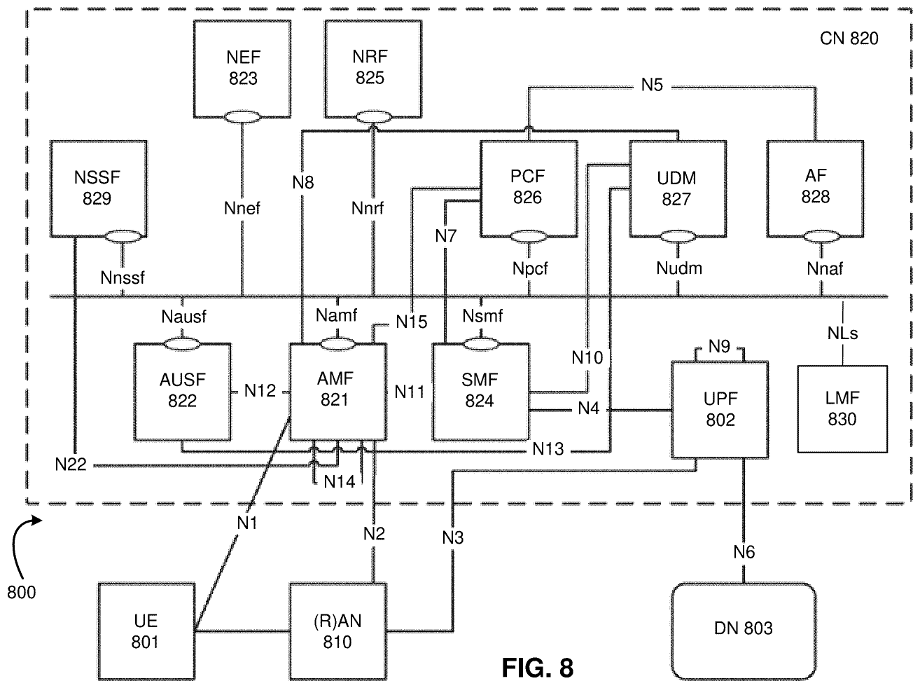

### FIG. 8: Core Network

FIG. 8 illustrates an example architecture of a system 800 including a core network (CN) 820 in accordance with various embodiments. The CN 820 may be a core network for a 5G System (which may be referred to as a 5GC). The system 800 is shown to include a UE 801, which may be the same or similar to the UEs 106A, 106B, or 106N discussed previously; a (R)AN 810, which may be the same or similar to the BSs 102A or 102N discussed previously; and a data network (DN) 803, which may be, for example, operator services, Internet access, or 3rd party services; and a CN 820. The CN 820 may include a number of network functions including an Authentication Server Function (AUSF) 822; an Access and Mobility Management Function (AMF) 821; a Session Management Function (SMF) 824; a Network Exposure Function (NEF) 823; a Policy Control Function (PCF) 826; a Network Repository Function (NRF) 825; a Unified Data Management (UDM) 827; an Application Function (AF) 828; a User Plane Function (UPF) 802; and a Network Slice Selection Function (NSSF) 829. These network functions may be implemented, in some cases, as virtualized software based functions/services.

The UPF 802 may act as an anchor point for intra-RAT and inter-RAT mobility, an external packet data unit (PDU) session point of interconnect to DN 803, and a branching point to support mufti-homed PDU session. A PDU session is a logical connection between the UE and the DN. The UPF 802 may also perform packet routing and forwarding, perform packet inspection, enforce the user plane part of policy rules, lawfully intercept packets (user plane (UP) collection), perform traffic usage reporting, perform quality of service (QoS) handling for a user plane (e.g., packet filtering, gating, UL/DL rate enforcement), perform Uplink Traffic verification (e.g., Service Data Flows (SDF) to QoS flow mapping), transport level packet marking in the uplink and downlink, and perform downlink packet buffering and downlink data notification triggering. UPF 802 may include an uplink classifier to support routing traffic flows to a data network, The DN 803 may represent various network operator services, Internet access, or third party services. DN 803 may include, or be similar to, application server 104 discussed previously. The UPF 802 may interact with the SMF 824 via an N4 reference point between the SMF 824 and the UPF 802.

The AUSF 822 may store data for authentication of UE 801 and handle authentication-related functionality, The AUSF 822 may facilitate a common authentication frame work for various access types. The AUSF 822 may communicate with the AMF 821 via an N12 reference point between the AMF 821 and the AUSF 822; and may communicate with the UDM 827 via an N13 reference point between the UDM 827 and the AUSF 822. Additionally, the AUSF 822 may exhibit an Nausf service-based interface.

The AMF 821 may be responsible for registration management (e.g., for registering UE 801, etc.), connection management, reachability management, mobility management, and lawful interception of AMF-related events, and access authentication and authorization. The AMF 821 may be a termination point for the an N11 reference point between the AMF 821 and the SMF 824. The AMF 821 may provide transport for SM messages between the UE 801 and the SMF 824, and act as a transparent proxy for routing SM messages. AMF 821 may also provide transport for Short Message Service (SMS) messages between UE 801 and an SMSF (not shown by FIG. 8). AMF 821 may act as a security anchor function (SEAF), which may include interaction with the AUSF 822 and the UE 801, receipt of an intermediate key that was established as a result of the UE 801 authentication process. Where Universal Subscriber Identity Module (USIM) based authentication is used, the AMF 821 may retrieve the security material from the AUSF 822. AMF 821 may also include a Security Context Management (SCM) function, which receives a key from the SEAF that it uses to derive access-network specific keys. Furthermore, AMF 821 may be a termination point of a RAN control plane (CP) interface, which may include or be an N2 reference point between the (R)AN 810 and the AMF 821; and the AMF 821 may be a termination point of NAS (NI) signaling, and perform NAS ciphering and integrity protection.

AMF 821 may also support NAS signaling with a UE 801 over a non-3GPP Inter-Working Function (N3IWF) interface. The N3IWF may be used to provide access to untrusted entities. N3IWF may be a termination point for the N2 interface between the (R)AN 810 and the AMF 821 for the control plane, and may be a termination point for the N3 reference point between the (R)AN 810 and the UPF 802 for the user plane. As such, the AMF 821 may handle N2 signaling from the SMF 824 and the AMF 821 for PDU sessions and encapsulate/de-encapsulate packets for IPSec and N3 tunneling, mark N3 user-plane packets in the uplink, and enforce QoS corresponding to N3 packet marking while considering QoS requirements associated with such marking received over N2. N3IWF may also relay uplink and downlink control plane non-access stratum (NAS) signaling between the UE 801 and AMF 821 via an N1 reference point between the UE 801 and the AMF 821, and relay uplink and downlink user-plane packets between the UE 801 and UPF 802. The N3IWF also provides mechanisms for internet protocol security (IPsec) tunnel establishment with the UE 801. The AMF 821 may exhibit an Namf service based interface, and may be a termination point for an N14 reference point between two AMFs 821 and an N17 reference point between the AMF 821 and a 5G Equipment Identity Register (5G-EIR) (not shown by FIG. 8).

The UE 801 may need to register with the AMF 821 in order to receive network services. Registration Management (RM) is used to register or deregister the UE 801 with the network (e.g., AMF 821), and establish a UE context in the network (e.g., AMF 821). The UE 801 may operate in an RM-REGISTERED state or an RM-DEREGISTERED state. In the RM-DEREGISTERED state, the UE 801 is not registered with the network, and the UE context in AMF 821 holds no valid location or routing information for the UE 801 so the UE 801 is not reachable by the AMF 821. In the RM REGISTERED state, the UE 801 is registered with the network, and the UE context in AMF 821 may hold a valid location or routing information for the UE 801 so the UE 801 is reachable by the AMF 821. In the RM-REGISTERED state, the UE 801 may perform mobility registration update procedures, perform periodic registration update procedures triggered by expiration of the periodic update timer (e.g., to notify the network that the UE 801 is still active), and perform a Registration Update procedure to update UE capability information or to re-negotiate protocol parameters with the network, among others.

The AMF 821 may store one or more RM contexts for the UE 801, where each RM context is associated with a specific access to the network. The RM context may be a data structure, database object, etc. that indicates or stores, inter glia, a registration state per access type and the periodic update timer. The AMF 821 may also store a 5GC mobility management (MM) context that may be the same or similar to the evolved packet services (EPS) Mobility Management (E)MM context discussed previously. In various embodiments, the AMF 821 may store a CE mode B Restriction parameter of the UE 801 in an associated MM context or registration management (RM) context. The AMF 821 may also derive the value, when needed, from the UE's usage setting parameter already stored in the UE context (and/or MM/RM context).

Connection Management (CM) may be used to establish and release a signaling connection between the UE 801 and the AMF 821 over the N1 interface. The signaling connection is used to enable NAS signaling exchange between the UE 801 and the CN 820, and comprises both the signaling connection between the UE and the AN (e.g., RRC connection or UE-N3IWF connection for non-3GPP access) and the N2 connection for the UE 801 between the AN (e.g., AN 810) and the AMF 821. The UE 801 may operate in one of two CM states, CM-IDLE mode or CM-CONNECTED mode. When the UE 801 is operating in the CM-IDLE state/mode, the UE 801 may have no NAS signaling connection established with the AMF 821 over the N1 interface, and there may be (R)AN 810 signaling connection (e.g., N2 and/or N3 connections) for the UE 801. When the UE 801 is operating in the CM-CONNECTED state/mode, the UE 801 may have an established NAS signaling connection with the AMF 821 over the N1 interface, and there may be a (R)AN 810 signaling connection (e.g., N2 and/or N3 connections) for the UE 801. Establishment of an N2 connection between the (R)AN 810 and the AMF 821 may cause the UE 801 to transition from CM-IDLE mode to CM-CONNECTED mode, and the UE 801 may transition from the CM-CONNECTED mode to the CM-IDLE mode when N2 signaling between the (R)AN 810 and the AMF 821 is released.

The SMF 824 may be responsible for session management (SM) session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 801 and a data network (DN) 803 identified by a Data Network Name (DNN). PDU sessions may be established upon UE 801 request, modified upon UE 801 and CN 820 request, and released upon UE 801 and CN 820 request using NAS SM signaling exchanged over the N1 reference point between the UE 801 and the SMF 824. Upon request from an application server, the CN 820 may trigger a specific application in the UE 801. In response to receipt of the trigger message, the UE 801 may pass the trigger message (or relevant parts/information of the trigger message) to one or more identified applications in the UE 801. The identified application(s) in the UE 801 may establish a PDU session to a specific data network name (DNN). The SMF 824 may check whether the UE 801 requests are compliant with user subscription information associated with the UE 801. In this regard, the SMF 824 may retrieve and/or request to receive update notifications on SMF 824 level subscription data from the UDM 827.

The SMF 824 may include the following roaming functionality: handling local enforcement to apply QoS SLAB virtual Public Land Mobile Network (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 824 may be included in the system 800, which may be between another SMF 824 in a visited network and the SMF 824 in the home network in roaming scenarios. Additionally, the SMF 824 may exhibit the Nsmf service-based interface.

The NEF 823 may provide means for securely exposing the services and capabilities provided by 3GPP network functions for third party, internal exposure/re-exposure, Application Functions (e.g., AF 828), edge computing or fog computing systems, etc. In such embodiments, the NEF 823 may authenticate, authorize, and/or throttle the AFS. NEF 823 may also translate information exchanged with the AF 828 and information exchanged with internal network functions. For example, the NEF 823 may translate between an AF-Service-Identifier and an internal SCC information. NEF 823 may also receive information from other network functions (NFs) based on exposed capabilities of other network functions. This information may be stored at the NEF 823 as structured data, or at a data storage NF using standardized interfaces. The stored information can then be re-exposed by the NEF 823 to other NFs and AFs, and/or used for other purposes such as analytics. Additionally, the NEF 823 may exhibit an Nnef service-based interface.

The NRF 825 may support service discovery functions, receive NF discovery requests from NF instances, and provide the information of the discovered NF instances to the NF instances. NRF 825 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 825 may exhibit the Nnrf service based interface.

The PCF 826 may provide policy rules to control plane function(s) to enforce them, and may also support unified policy framework to govern network behavior, The PCF 826 may also implement a front end (FE) to access subscription information relevant for policy decisions in a UDR of the UDM 827. The PCF 826 may communicate with the AMF 821 via an N15 reference point between the PCF 826 and the AMF 821, which may include a PCF 826 in a visited network and the AMF 821 in case of roaming scenarios. The PCF 826 may communicate with the AF 828 via an NS reference point between the PCF 826 and the AF 828; and with the SMF 824 via an N7 reference point between the PCF 826 and the SMF 824, The system 800 and/or CN 820 may also include an N24 reference point between the PCF 826 (in the home network) and a PCF 826 in a visited network, Additionally, the PCF 826 may exhibit an Npcf service-based interface.

The UDM 827 may handle subscription-related information to support the network entities' handling of communication sessions, and may store subscription data of UE 801. For example, subscription data may be communicated between the UDM 827 and the AMF 821 via an NS reference point between the UDM 827 and the AMF. The UDM 827 may include two parts, an application FE and a UDR (the FE and UDR are not shown by FIG. 8). The UDR may store subscription data and policy data for the UDM 827 and the PCF 826, and/or structured data for exposure and application data (including PFDs for application detection, application request information for multiple UEs 801) for the NEF 823. The Nadr service-based interface may be exhibited by the UDR 221 to allow the UDM 827, PCF 826, and NEF 823 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 824 via an NI0 reference point between the UDM 827 and the SMF 824. UDM 827 may also support SMS management, wherein an SMS-FE implements the similar application logic as discussed previously. Additionally, the UDM 827 may exhibit the Nudm service based interface.

The AF 828 may provide application influence on traffic routing, provide access to the NCE, and interact with the policy framework for policy control. The NCE may be a mechanism that allows the CN 820 and AF 828 to provide information to each other via NEF 823, which may be used for edge computing implementations. In such implementations, the network operator and third party services may be hosted close to the UE 801 access point of attachment to achieve an efficient service delivery through the reduced end-to-end latency and load on the transport network. For edge computing implementations, the 5GC may select a UPF 802 close to the UE 801 and execute traffic steering from the UPF 802 to DN 803 via the N6 interface. This may be based on the UE subscription data, UE location, and information provided by the AF 828. In this way, the AF 828 may influence UPF (re) selection and traffic routing. Based on operator deployment, when AF 828 is considered to be a trusted entity, the network operator may permit AF 828 to interact directly with relevant NFs. Additionally, the AF 828 may exhibit an Naf service-based interface.

The NSSF 829 may select a set of network slice instances serving the UE 801. The NSSF 829 may also determine allowed Network Slice Selection Assistance Information (NSSAI) and the mapping to the subscribed single NSSAI (S-NSSAI) is, if needed. The NSSF 829 may also determine the AMF set to be used to serve the UE 801, or a list of candidate AMF(s) 821 based on a suitable configuration and possibly by querying the NRF 825. The selection of a set of network slice instances for the UE 801 may be triggered by the AMF 821 with which the UE 801 is registered by interacting with the NSSF 829, which may lead to a change of AMF 821. The NSSF 829 may interact with the AMF 821 via an N22 reference point between AMF 821 and NSSF 829; and may communicate with another NSSF 829 in a visited network via an N31 reference point (not shown by FIG. 8). Additionally, the NSSF 829 may exhibit an Nnssf service-based interface.

As discussed previously, the CN 820 may include a short message service function (SMSF), which may be responsible for SMS subscription checking and verification, and relaying SM messages to/from the UE 801 to/from other entities, such as an SMS-GMSC/IWMSC/SMS-router. The SMS may also interact with AMF 821 and UDM 827 for a notification procedure that the UE 801 is available for SMS transfer (e.g., set a UE not reachable flag, and notifying UDM 827 when UE 801 is available for SMS).

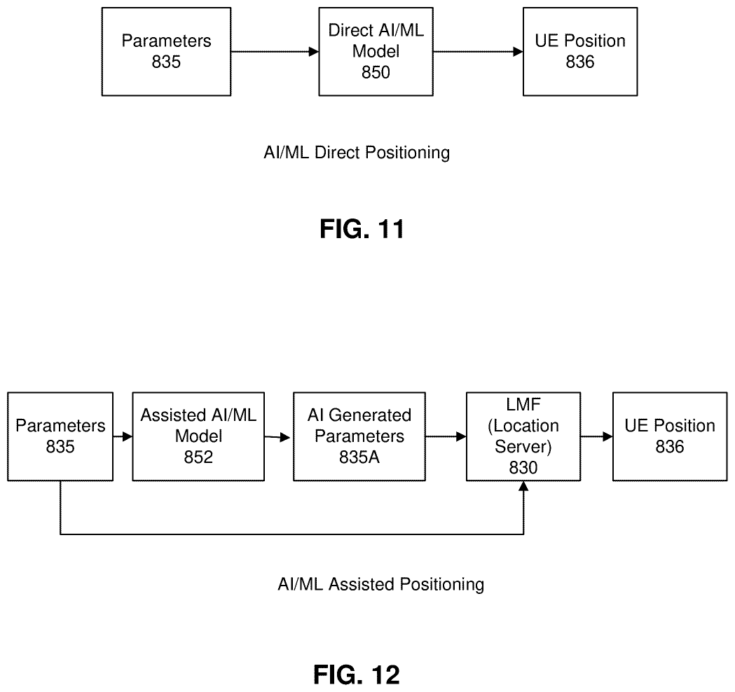

The CN 820 may further include a location management function (LMF) 830. The LMF 830 receives measurements and assistance information from the base station 102A and the UE 106 via the AMF 821 over the NLs interface to compute the position of the UE 106. The AMF 821 and LMF 830 are described in more detail in relation to FIG. 11.

The CN 820 may also include other elements that are not shown by FIG. 8, such as a Data Storage system/architecture, a 5G-EIR, a Security Edge Protection Proxy (SEPP), and the like. The Data Storage system may include a Structured Data Storage Network Function (SDSF), air Unstructured Data Storage Function (UDSF), and/or the like. Any network function (NF) may store and retrieve unstructured data into/from the UDSF (e.g., UE contexts), via N18 reference point between any NF and the UDSF (not shown by FIG. 8), Individual NFs may share a UDSF for storing their respective unstructured data or individual NFs may each have their own UDSF located at or near the individual NFs. Addition-ally, the UDSF may exhibit an Nudsf service-based interface (not shown by FIG. 8). The 5G-EIR may be an NF that checks the status of permanent equipment identifier (PEI) for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 8 for clarity. In one example, the CN 820 may include an Nx interface, which is an inter-CN interface between a mobility management entity (MME) and the AMF 821 in order to enable interworking between CN 820 and a CN in a 4G system. Other example interfaces/reference points may include an N5G-EIR service-based interface exhibited by a 5G-EIR, an N27 reference point between the NRF in the visited network and the NRF in the home network; and an N31 reference point between the NSSF in the visited network and the NSSF in the home network.

The CN 820 can be part of the NW 100. As described herein, the NW 100 and/or the CN 820 can transmit and receive messages with the UE 106 via the base station 102. In addition, the NW 100 (e.g. a server operating in the network) and/or the CN 820 can dynamically manage a database of ML models.

In some embodiments, the system 800 and the core network (CN) 820 can include an over the air (OTA) or over the top (OTT) server 831.

### FIGS. 8-16: Legacy UE Positioning Techniques

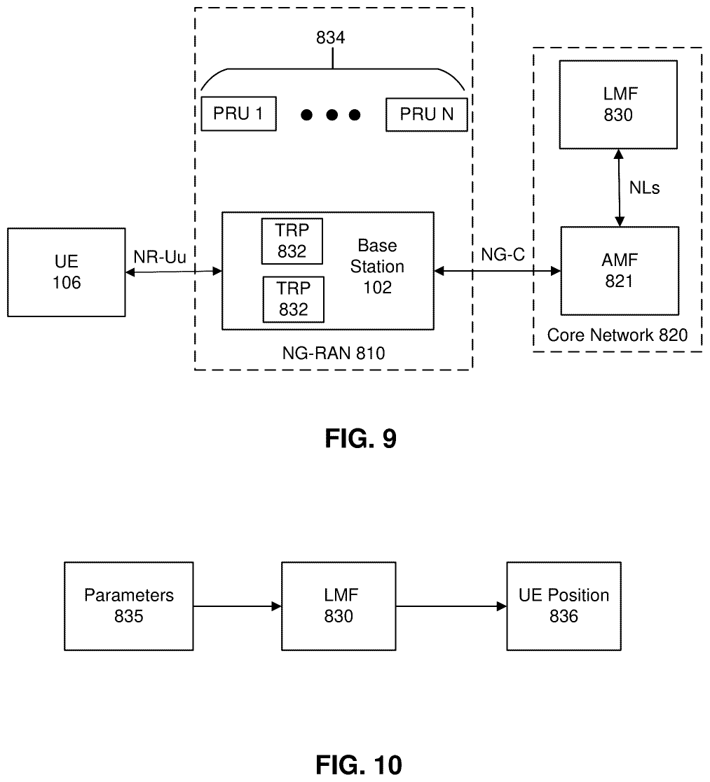

Referring to FIGS. 8 and 9, under Legacy 3GPP Releases, the location management function (LMF) 830 is central in the 3GPP NR (5G) positioning architecture. The LMF 830 is the network entity in the CN 820 supporting the following functionality. The LMF: supports location determination for a UE 106, obtains downlink location measurements or a location estimate from the UE 106, obtains uplink location measurements from the NG RAN 810, obtains non-UE associated assistance data from the NG RAN 810, and provides broadcast assistance data to the UE 106.

The LMF 830 receives measurements and assistance information from the base station 102 and the UE 106 via the access and mobility management function (AMF) 821 over the NLs interface to support location determination of the UE 106. The LMF 830 may reside on one or more location servers 833 that includes one or more processors and a memory. The interface between the NG-RAN 810 (FIG. 9) and the CN 820 can carry the positioning information between the NG-RAN and LMF 830 over the next generation control plane interface (NG-C). The NG RAN 810 can configure the UE 106 using radio resource control (RRC) protocol over the NR-Uu interface. In short, the LMF 830 can be an enabler for localization purposes under Legacy Releases, is part of the CN 820, runs various localization algorithms, gathers location data from the NG-RAN 810 and base station 102, and returns the UE's 106 estimated location.

Referring now to only FIG. 9, the base station 102 may include one or more physical transmission-reception points (TRPs) 832 that may or may not be co-located. For example, the TRP 832 may be an antenna of the base station 102 corresponding to a cell (or several cell sectors) of the base station 102. Where the base station 102 includes multiple co-located physical TRPs 832, the physical TRPs 832 may be an array of antennas (e.g., as in a multiple-input multiple-output (MIMO) system or where the base station 102 employs beamforming) of the base station 102. Where the base station 102 includes multiple non-co-located physical TRPs 832, the physical TRPs 832 may be a distributed antenna system (DAS) (a network of spatially separated antennas connected to a common source via a transport medium) or a remote radio head (RRH) (a remote base station connected to a serving base station). Alternatively, the non-co-located physical TRPs 832 may be the base station 102 receiving the measurement report from a UE 106 and a neighbor base station whose reference radio frequency (RF) signals the UE 106 is measuring. Because a TRP 832 is the point from which the base station 102 transmits and receives wireless signals, as used herein, references to transmission from or reception at a base station 102 are to be understood as referring to a particular TRP 832 of the base station 102. Thus, the base station 102 may transmit reference signals to the UE 106 to be measured by the UE 106, and/or may receive and measure signals transmitted by the UE 106.

Positioning reference units (PRUs) 1 to N 834 may assist in positioning of the UE 106. PRUs 834 may have known locations and can perform positioning measurements (e.g., reference signal time difference (RSTD), reference signal receive power (RSRP), Rx-Tx time difference, observed time difference of arrival (OTDOA), etc.) related to a target UE and report these measurements to the LMF 830. A PRU 834 may be, for example a device that may be used to obtain location related information for nodes in a Radio Access Network (RAN) (such as a Next Generation RAN (NG-RAN)) unrelated to specific target UEs. Another example of a PRU 834 may be a reference UE, which is a device similar to or the same as the UE 106, that may be used to obtain location related information for one or more other target UEs. One or more PRUs 834 with known locations may be used to assist or enable the obtaining location of the UE 106. For example, the one or more PRUs 834 may obtain location measurements of signals transmitted by the UE 106, and/or the UE 106 may obtain location measurements of signals transmitted by the one or more PRUs 834. The location measurements may then be used to determine the location(s) of the one or more target UEs by the LMF 830.

In legacy based positioning, the LMF 830 interacts with the TRPs 832 and the UEs. Referring to FIG. 10, there is shown a summary of the positioning process for AI/ML based positioning to determine a location of the UE 106. Parameters 835 provided by the UE 106 and/or NG-RAN 810 (base station 102 and PRUs 834) are provided to the AI/ML model that can be located at the UE or at the LMF 830. The AI/ML model can be used in multiple different cases.

The LMF 830 then uses the parameters/inputs 835 in algorithms to determine a UE position 836 (in AI/ML based positioning). The parameters 835 may include, but are not limited to, the following: Sounding Reference Signal (SRS) measurements, Positioning Reference Signals (PRS) measurements, Time Difference of Arrival (TDOA), Angle of Departure (AoD), and Angle of Arrival (AoA) measurements. The UE is configured to transmit the SRS and receive the PRS from the base station. The base station is configured to transmit the PRS and receive the SRS from the UE.

### 3GPP Release 18 Study for AI/ML Positioning

The 3GPP Release 18 initiated a study item, as provided in technical report 3GPP TR 38.843 v18.0.0 (January 2024), to explore the potential of artificial intelligence and machine learning (AI/ML) in the context of positioning for Release 19. The study identified the following five cases for consideration.

Case 1: UE-based positioning with a UE-side model, direct AI/ML.

Case 2a: UE-assisted/LMF-based positioning with a UE-side model, AI/ML assisted positioning.

Case 2b: UE-assisted/LMF-based positioning with an LMF-side model, direct AI/ML positioning.

Case 3a: NG-RAN node assisted positioning with a gNB-side model, AI/ML assisted positioning.

Case 3b: NG-RAN node assisted positioning with an LMF-side model, direct AI/ML positioning.

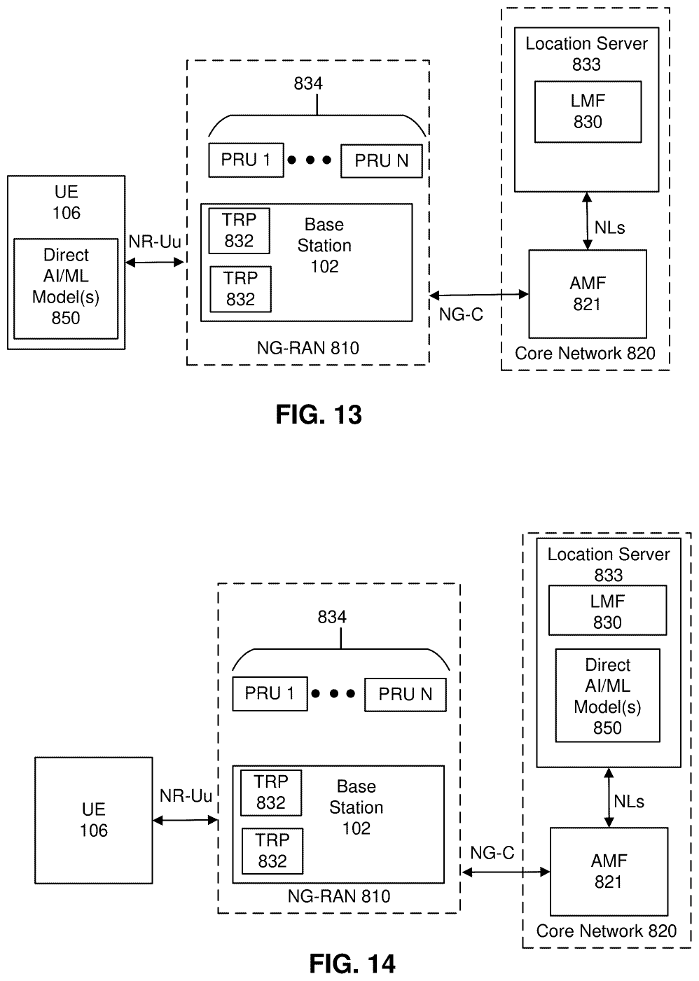

The study identified two primary modalities through which AI/ML could be beneficial: direct and assisted AI/ML positioning. Under direct AI/ML positioning, the AI/ML model can directly output the location of the UE. For example, as shown in FIG. 11, parameters 835 are provided to a direct AI/ML model 850. The direct model 850 then outputs the UE position 836. Under the study, the direct AI/ML model 850 may be a UE-side model or an LMF-side model. For example, as shown in FIG. 13, the direct AI/ML model 850 is UE-side, meaning that the model input data is internally available to the AI/ML model located at the UE 106. As shown in FIG. 14, the direct AI/ML model 850 is an LMF-side model, meaning that model input data can be generated by the UE 106 or the base station 102 and forwarded to the AI/ML model 850 at the LMF 830.

Under assisted AI/ML positioning, rather than directly determining the UE's location, the AI/ML model aids 3GPP Legacy approaches by outputting AI generated parameters or by refining existing parameters. For example, as shown in FIG. 12, parameters 835 are provided to an assisted AI/ML model 852. The model 852 then provides AI/ML generated parameters 835A to the LMF 830. The LMF 830 then determines the UE position 836 using Legacy techniques and the AI/ML generated parameters 835A, and optionally one or more of parameters 835 or an improvement of one or more of the parameters 835.

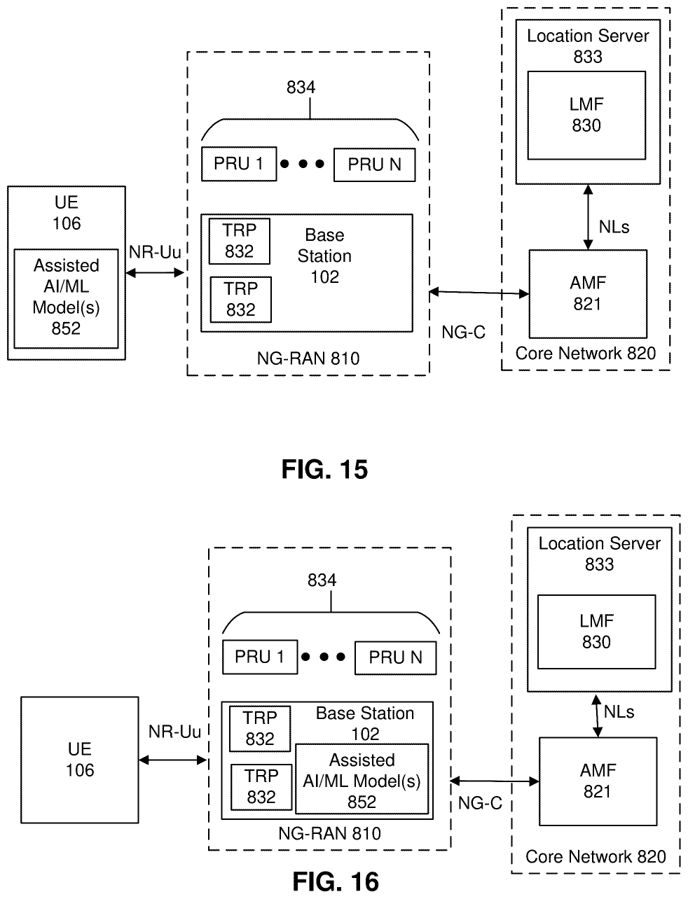

The assisted AI/ML model 852 may be a UE-side or a base-station side model. For example, as shown in FIG. 15, the assisted AI/ML models 852 is a UE-side model, meaning that the model input data is internally available to the AI/ML model 852 at the UE 106. As shown in FIG. 16, the assisted AI/ML model AI/ML 852 is a base-station side model, meaning that model input data can be generated by the UE 106 or the base station 102, and sent to the assisted AI/ML model 852 residing at the base station 102.

It will be appreciated that the direct AI/ML model 850 and the assisted AI/ML model 852 may each comprise more than one model to provide model switching capabilities to provide for different scenarios, as further described below. In addition, the direct AI/ML model 850 and the assisted AI/ML model 852 may each be one of the following model types: supervised, semi-supervised, and unsupervised.

### AI/ML Model Development

The development of the AI/ML models 850, 852 may comprise four main phases: a training, emulation (validation), deployment, and inference phase. The main task involved in each phase are briefly described in the proceeding paragraphs.

Training Phase: In this phase, the AI model is trained on a dataset. This involves feeding the model with input data and corresponding correct output labels, allowing the model to learn patterns and relationships within the data. Training typically involves optimization algorithms to adjust the model's parameters to minimize errors.

Emulation Phase: In the emulation phase, the trained model is tested extensively to ensure it performs well on data it hasn't seen before. This phase involves evaluating the model's performance metrics such as accuracy, precision, recall, etc., using validation datasets. Emulation helps identify any issues with the model's generalization and performance before deployment.

Deployment Phase: Once the model has been trained and successfully emulated, it's ready for deployment. Deployment involves integrating the model into a production environment where it can make predictions or classifications on new, unseen data. This may involve creating application programming interfaces (APIs) or integrating the model into applications or systems where it will be used.

Inference Phase: In this phase, the deployed model is used to make predictions or classifications on real-world data referred to herein as a “scenario.” A scenario typically refers to a specific situation or problem domain in which an AI/ML model is applied or evaluated. Scenarios help frame the context in which AI/ML model is are deployed. The AI/ML model takes input data, processes it, and produces an output referred to as an inference, e.g., position information related to a UE (direct) or parameters used in a Legacy LMF to determine position (assisted).

### AI Model Monitoring

Monitoring and Evaluation: A monitoring entity, such as a UE, base station, or location server, continuously monitors various factors such as data characteristics, system performance metrics, or environmental conditions.

Decision Making: Based on the monitored factors, the monitoring entity decides whether to switch to a different machine learning model that is better suited for the current conditions or task, finetune the current model using transfer learning to better match the environmental conditions or indicate the need to fall back to non-AI based positioning.

AI model switching refers to the process of dynamically selecting or switching between different machine learning models or algorithms based on certain conditions or criteria. This approach is often used in adaptive systems where the optimal model for a particular task may change over time or in different contexts. AI model switching may include the following.

Model Selection: The monitoring entity selects the most appropriate model from a set of pre-defined models or algorithms. This selection can be based on factors such as accuracy, efficiency, or robustness.

Model finetuning: Once a model is selected, the model can be further trained on a dataset that is specific to a task. This is known as finetuning. Finetuning a pre-trained model can reduce the amount of initial training for the model, while ensuring the model is trained for the specific task for which it will be used. This enables models to be trained more generally for multiple specific tasks. Finetuning a pre-trained model may be optional, depending on how different the initial training is from the end use of the model.

Adaptation: Once a new model is selected and optionally finetuned, the monitoring entity adapts its operation to use the newly chosen model for making predictions or decisions.

### RedCap UE Relaxed RRM Measurement

Radio resource management (RRM) messaging is used in 3GPP 5G to enable quality of service (QoS) communications performance between UEs 106, base stations 102, and the network 100 or core network 820 to be controlled. Measurements can be made by a UE regarding the UE's ability to communicate with neighboring cells, including intra-cell measurements, inter-cell measurements, and inter-radio access technology (RAT) measurements. These measurements can then be used by the UE to perform a handover from one BS to another BS based on the measurements. The more measurements that are performed, the more accurate the QoS can be. However, the measurements can take time, power, and bandwidth resources, which results in large uplink (UL) reporting overhead and control signaling overhead.

For UEs with limited power capacity, such as a reduced capacity (RedCap) UE, performing multiple measurements and reporting them with RRM communication can consume a significant amount of a RedCap device's power. Therefore, a RedCap UE, such as a wearable UE, can support a 3GPP defined relaxed radio resource management (RRM) measurement feature based on a radio frequency (RF) condition and a motion status. For wearable devices, a UE can further optimize the RRM relaxed measurement based on a service status to save more power. In accordance with 3GPP technical specification TS 38.304 V17.9.0 (2024 June), it is up to UE implementation when to start performing relaxed RRM measurements in a radio resource control (RRC) Idle/Inactive mode if multiple methods are configured.

The current 3GPP limitation only defines a trigger condition-based reference signal received power (RSRP) status. However, there can be different user scenarios for wearable devices. The current 3GPP limitation only defines a specific extended measurement period. But in some scenarios, even these extended measurement periods may not be necessary. In addition, the current 3GPP limitation does not define the procedure of NW/UE behavior in a connected mode. The UE may be optimized for more power savings based on a different NW implementation.

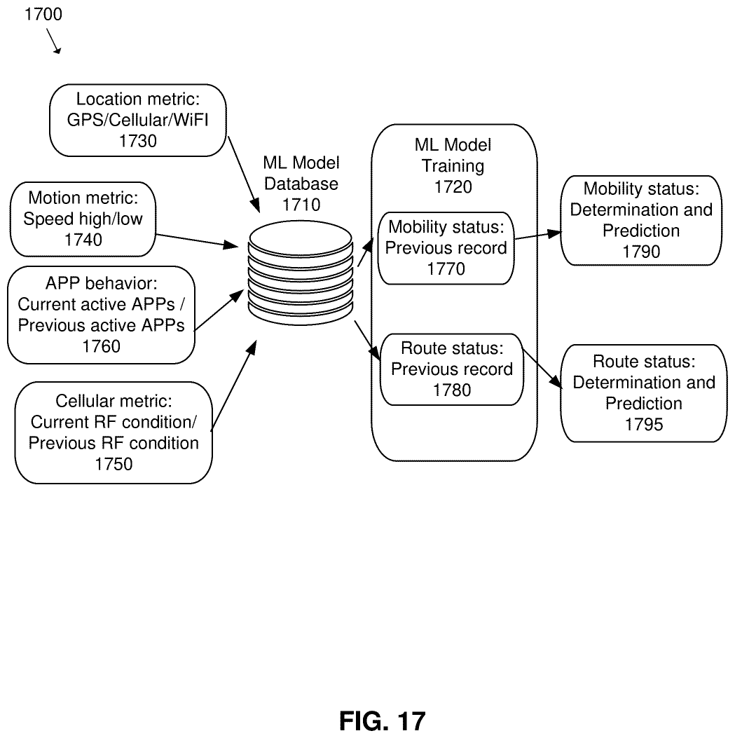

### FIG. 17: ML Model Structure for Service-Based Scenario

FIG. 17 illustrates a diagram of an example of an ML model structure 1700 for service based on a scenario, according to some embodiments. The ML model structure 1700 can comprise an ML model database 1710 that can receive inputs, such as metrics and application (APP) behavior. The ML model structure 1700 can also comprise an ML model training 1720 to provide inferences as outputs, such as a determined or predicted mobility or route status inference.

The metrics input to the ML model database 1710 can comprise one or more location metrics 1730, motion metrics 1740 or cellular metrics 1750. The location metrics 1730 can comprise one or more of GPS positioning information, cellular location information or WiFi location information. The motion metrics 1740 can comprise one or more of a high speed motion indication or a low speed motion indication. The cellular metrics 1750 can comprise one or more of a current RF condition or a previous RF condition.

The metrics input to the ML model database 1710 can also comprise one or more application (APP) behaviors 1760. The APP behaviors 1760 can comprise indications from one or more of a current active APP or a previously active APP. For example, when a specific application is used on a UE, such as an application designed for a specific type of activity or exercise, such as a running app, a biking app, a yoga app, and so forth, the type of APP used can assist the ML model in predicting the type of service-based scenario for the UE.

The ML model training 1720 can comprise one or more of a mobility status 1770 or a route status 1780. The mobility status 1770 and the route status 1780 can comprise previous records.

The ML model training 1720 can output a mobility status inference 1790 and/or a route status inference 1795. The mobility status 1790 and the route status inference 1795 can each comprise a determination or service scenarios (e.g. mobility or stationary, or fixed or normal route) and a prediction that can be used to identify when a relaxed RRM measurement behavior can be used by a RedCap device.

### Service-Based Dynamic Relaxed Measurement in Idle/Inactive Mode

According to some embodiments, the RedCap UE 106 can dynamically select a preferred radio resource management (RRM) relaxed measurement based on an available service-based scenario, such as a stationary scenario, a fixed route scenario or a normal route scenario. For a stationary scenario, e.g. indoor fitness, the UE 106 can stop RRM measurements for intra/inter frequency and inter-RAT measurements when the cell coverage is available in a predetermined area, e.g. a fitness area. Since the RedCap device will only connect to a single base station or access point (AP) while operating in the predetermined area, it is not necessary for the RedCap device to perform inter/intra frequency measurements of other cells or other RATs and report those measurements via RRM signaling. This can significantly reduce power consumption at the RedCap device.

When the RedCap UE is used on a fixed route, e.g. running on a regular route, the UE 106 can perform an RRM measurement on a specific intra/inter frequency and an inter-RAT based on a predefined route that can be identified by an ML model. For a normal route, e.g. a new route for climbing, running, or walking, the UE 106 cam perform an RRM measurement on a specific intra/inter frequency and an inter-RAT based on a predicted route by the ML model. The UE 106 can evaluate and predict the different routes using the ML model to infer which intra/inter frequency measurements or inter-RAT measurements are to be made based on the service-based scenario. For example, based on training data, the ML model can be used to infer which channels are used for communication between the RedCap UE and each base station or AP along a route, and limit the RRM measurements to those channels. This can significantly reduce the power consumption of the RedCap UE.

Table 1 lists examples of scenarios and RF condition evaluation factors utilized by the ML model.

TABLE 1

| | | RF condition | |
|---|---|---|---|
| | Stationary or | evaluation | |
| Scenario | Mobility | factors by ML | e.g. use case |
| Indoor | Stationary | Factors: | Indoor exercise |
| fitness | | 1. Indoor motion | on stationary |
| | | status | fitness equipment |
| | | 2. RF condition | |
| | | evaluation | |
| | | 3. Previous record | |
| | | checking if | |
| | | applicable | |
| Indoor | Low mobility | Factors: | Indoor swimming |
| swimming | | 1. Indoor motion | poor with round- |
| | | status | trip lane |
| | | 2. swimming | |
| | | activity detection | |
| | | 3. RF condition | |
| | | evaluation | |
| | | 4. Previous record | |
| | | checking if | |
| | | applicable | |
| Outdoor | Mobility | Factors: | regular running/ |
| Fixed | | 1. outdoor motion | climbing route |
| route | | status | |
| | | 2. RF condition | |
| | | evaluation | |
| | | 3. Previous record | |
| | | checking if | |
| | | applicable | |
| | | 4. Predefined | |
| | | RRM pattern by | |
| | | ML | |
| Outdoor | Mobility | Factors: | new |
| Normal | | 1. outdoor motion | running/climbing |
| route | | status | route |
| | | 2. RF condition | |
| | | evaluation | |
| | | 3. Previous record | |
| | | checking if | |
| | | applicable | |
| | | 4. Predicted RRM | |
| | | pattern by ML | |
| Outdoor | Stationary | Factors: | outdoor stationary |
| stationary | | 1. Indoor motion | exercise |
| area | | status | |
| | | 2. RF condition | |
| | | evaluation | |
| | | 3. Previous record | |
| | | checking if | |
| | | applicable | |

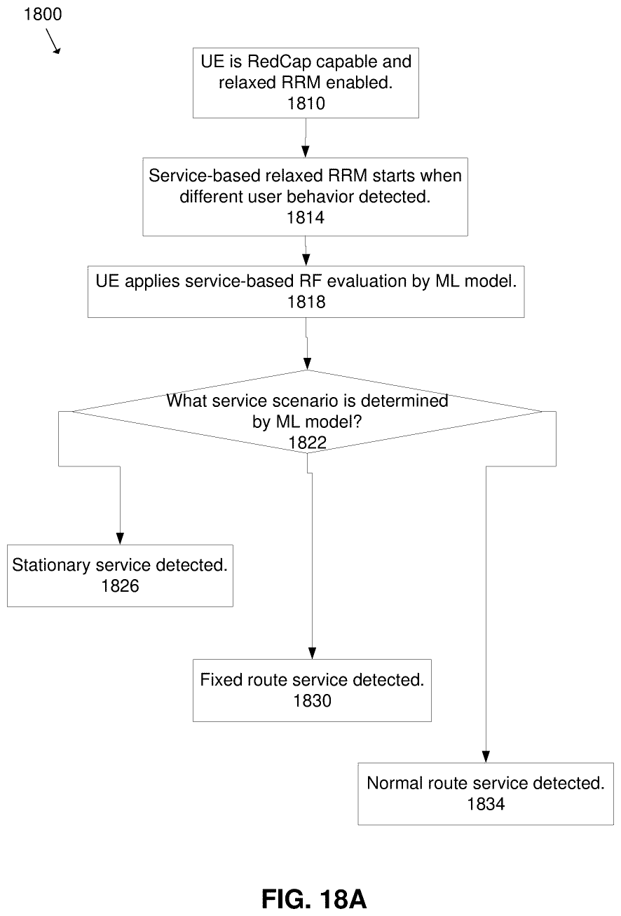

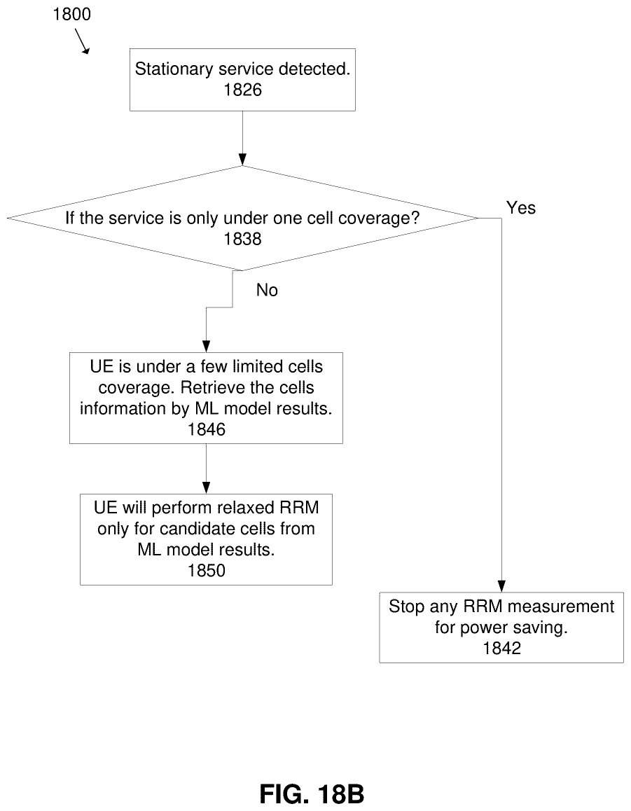

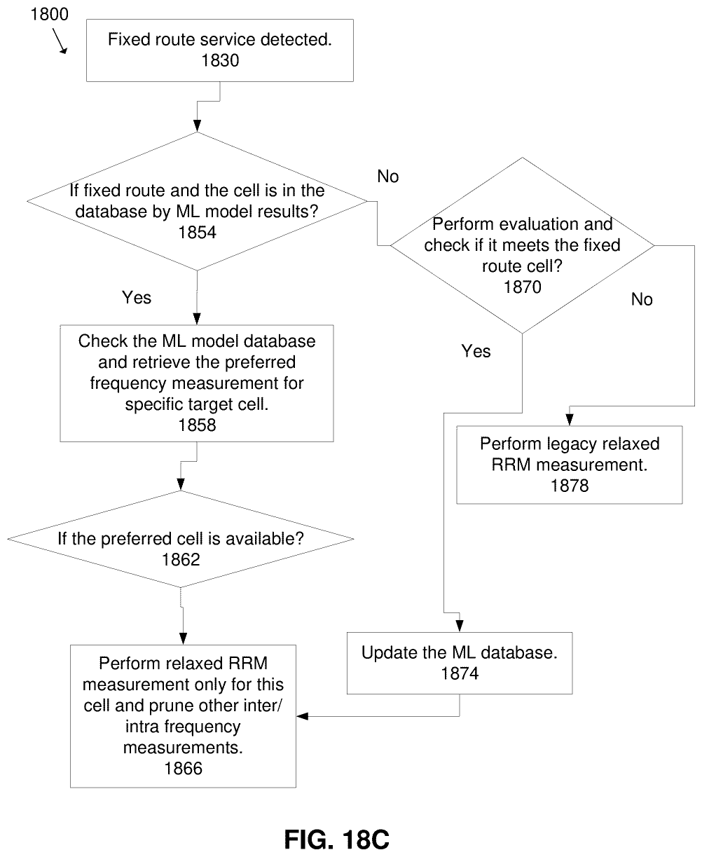

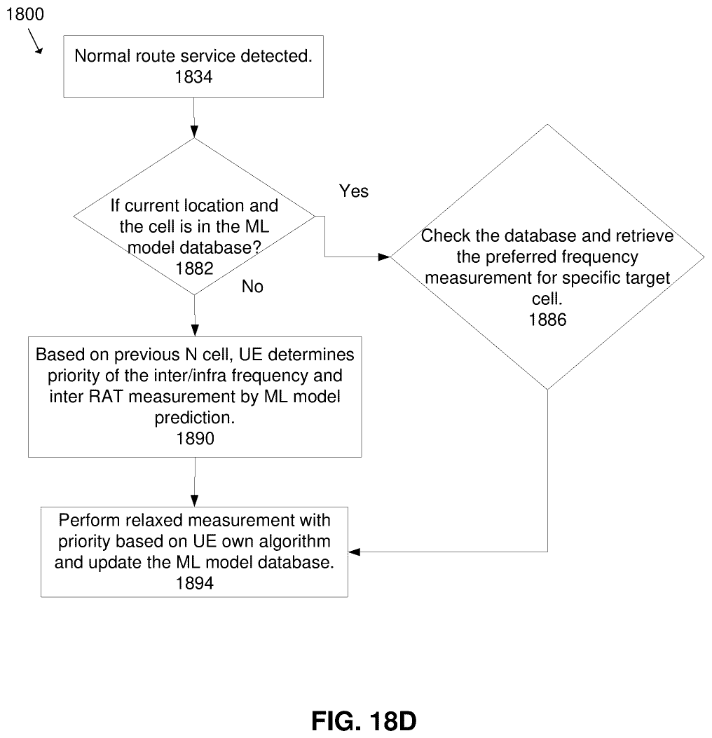

### FIGS. 18A-D: Service-Based Dynamic Relaxed RRM Measurement in Idle/Inactive Mode

FIGS. 18A-D illustrate flow charts for an example system and method 1800 of service-based dynamic relaxed RRM measurement in an idle/inactive mode in a wireless communication system, according to some embodiments.

Referring to FIG. 18A, the system and method 1800 can comprise a reduced capacity (RedCap) UE 106, such as a wearable, and that is relaxed RRM measurement enabled, indicated at 1810. The method 1800 can comprise detecting 1814, at the UE 106, a different user behavior. The different user behavior can be implemented with or can include a different UE 106 behavior. For example, the different user behavior may be the user beginning an exercise routine, such as running, walking, swimming, or going to the gym. The exercise routine may be a routine that the user repeats, such as a daily or weekly routine.

The method 1800 can comprise applying 1818, at the UE 106, a service-based radio frequency (RF) evaluation using the ML model. The ML model can utilize input factors, such as non-cellular conditions and cellular conditions. The non-cellular conditions can include motion sensors, a GPS, user settings, and/or previous UE behavior, if available. The cellular conditions can include a current RF status and/or previous RF recording data, such as the RF channels used by each

BS or AP in an area or along a path used during the exercise routine. The ML model can output evaluation results for service scenario identity and/or prediction of RRM relaxed behavior.

The service-based scenario validation can include a first check and a second check. The first check (check #1) can include whether the UE 106 is stationary (e.g. limited area with a few cells) or mobile. When the UE 106 is stationary, the UE 106 can be considered under a stable RF without handover (HO) and/or re-selection (or limited cells coverage). If the UE 106 is mobile, the UE 106 can be considered as moving in different RF coverage with multiple HO/re-selections. The second check (check #2) can include whether the UE 106 is on a fixed route or a new route for current service for mobility. When the UE 106 is on a fixed route, i.e. in a regular or predefined route, the UE 106 can retrieve the cellular information based on ML model results. When the UE 106 is on a new route, the UE 106 can predict the cellular information for handling relaxed RRM measurements with priority. Based on the determined service-based scenario and the service-based cellular RF information, the UE 106 can perform a relaxed RRM measurement for each service-based scenario, as discussed below.

The ML model can determine a mobility or stationary (included limited coverage) scenario of the UE 106 based on criteria, such as non-cellular and/or cellular information. The non-cellular information can include: whether GPS information indicates the UE is stationary (or in limited areas); whether a user setting on an application of the UE indicates a stationary activity (e.g. yoga); and/or whether motion sensors indicate a stationary service. The cellular information can include: whether the UE stays on one specific cell or AP during a service duration; whether the UE moves under a few cells (e.g. a swimming route under two cells); and/or whether the UE meets criteria defined in the 3GPP standard.

The ML model can determine a fixed or normal route of the UE 106 based on criteria, such as non-cellular and/or cellular information. The non-cellular information can include: whether GPS information indicates a fixed route (e.g. a predefined running route); and/or whether a user behavior ML model indicates a fixed route (e.g. user and UE running a same route on a regular basis). The cellular information can include: whether the UE is camped on previous cells that match with a recorded cell in an ML model database; and/or whether a predicted cell band, channel or frequency from an ML model match with camped cells.

The method 1800 can comprise determining 1822, at the UE 106, a service-based scenario, such as a stationary service 1826, a fixed route service 1830, or a normal route service 1834. According to some embodiments, the UE 106 can use the ML model in determining 1822 the service-based scenario.

Referring to FIG. 18B, when the stationary service is detected 1826, the method 1800 can comprise determining 1838 whether the service is only under one cell coverage (e.g. one BS or AP). When the service is under one cell coverage, the method 1800 can comprise stopping 1842, at the UE 106, any RRM measurements for power saving. When the service is not under one cell coverage, i.e. the UE is under a few limited cell coverage, the method 1800 can comprise retrieving 1846, at the UE 106, the cells information by AI/ML results, such as the channels typically used by the UE 106 for communication with the cells. The method 1800 can further comprise performing 1850, at the UE 106, relaxed RRM measurements only for candidate cells (e.g. RRM measurements of specific cells, bands, or channels) inferred from the AI/ML results.

Referring to FIG. 18C, when the fixed route service is detected 1830, the method 1800 can comprise determining 1854, at the UE 106, when the fixed route and the cell are in the ML model database using ML model results. When the fixed route and the cell are in the ML model database, the method 1800 can comprise checking the ML model database and/or retrieving 1858 the preferred frequency measurement for a specific target cell, such as the band or channel typically used by the UE to communicate with the specific target cell. The method 1800 can further comprise determining 1862 when the preferred or specific target cell is available. For example, the specific target cell may be available only during non-peak commuter times. During the commute, the specific target cell may be unavailable since it is over-used during heavy traffic. The method 1800 can further comprise performing 1866, at the UE 106, relaxed RRM measurements only for the preferred or specific target cell while pruning other inter/intra frequency measurements. When the fixed route and the cell are not in the database, the method 1800 can comprise performing 1870 an evaluation to check when the fixed route service meets the fixed route cell. When the fixed route service meets the fixed route cell, the method 1800 can comprise updating 1874 the ML model database. When the fixed route service does not meet the fixed route cell, the method 1800 can comprise performing 1878, at the UE 106, legacy relaxed RRM measurements.

Referring to FIG. 18D, when the normal route service is detected 1834, the method 1800 can comprise determining 1882, at the UE 106, when a current location of the UE and the cell are in the ML model database. When the current location and cell are in the database, the method 1800 can comprise checking the database and retrieving 1886, at the UE 106, a preferred frequency measurement for a specific target cell. When the current location and cell are not in the database, the method 1800 can comprise determining 1890, priority of the inter/intra frequency and inter-RAT measurement by ML model prediction based on the previous N cells, where N is a positive integer. For example, the ML model can infer, based on the previous 3 cells that the UE used, what the next cell will be, and potentially which band or channel of the cell will be used by the UE. Accordingly, only that band or channel may be measured using RRM measurements. The method 1800 can further comprise performing 1894, at the UE 106, relaxed RRM measurements with priority based on a determination by the UE and updating the ML model database.

In one aspect, an apparatus of a reduced capability (RedCap) user equipment (UE) 106 can comprise one or more processors 402 and or 604 coupled to a memory 406 or 604G. The processors 402 can be configured to detect, at the UE 106, a service-based scenario of the UE 106. The service-based scenario can include at least one of a stationary scenario, a fixed route or a normal route. The processors 402 can apply, at the UE 106, a service-based radio frequency (RF) evaluation based on the service-based scenario using a machine learning (ML) model (e.g. 1700). The processors 604 can perform, at the UE 106, a relaxed radio resource management (RRM) measurement of one or more measurement objects (MOs) based on the service-based RF evaluation determined by the ML model and the service-based scenario.

In another aspect, the processors 402 and/or 604 can be configured to stop, at the UE 106, the RRM measurement of the one or more MOs based on the service-based RF evaluation determined by the ML model and the service-based scenario.

In another aspect, the processors 402 and/or 604 can be configured to dynamically relax the RRM measurement of the one or more MOs based on the service-based RF evaluation determined by the ML model and the service-based scenario.

In another aspect, the UE 106 can be in an idle mode or an inactive mode.

In another aspect, the processors 402 can be configured to train, at the UE 106, the ML model with one or more input factors including one or more of a location metric 1730, a motion metric 1740, an application (APP) behavior 1760, or a cellular metric 1750. The location metric 1730 can comprise one or more of a global positioning satellite (GPS) information, a cellular information, or a WiFi information. The motion metric 1740 can comprise a high speed or a low speed. The APP behavior 1760 can comprise a current active APP or a previous active APP. The cellular metric 1750 can comprise a current RF condition or a previous RF condition.

In another aspect, the processors 402 can be configured to obtain, at the UE 106, an output (e.g. inference) from the ML model. The output can comprise one or more of an evaluation result for a service scenario identity, or a prediction of an RRM relaxed behavior.

In another aspect, the processors 402 can be configured to determine, at the UE 106, when the UE 106 is stationary or mobile. The determination can be made using the ML model. The processors 402 and/or 604 can be configured to stop RRM measurement when the UE 106 is stationary.

In another aspect, the processors 402 can be configured to determine, at the UE 106, when the UE 106 is stationary or mobile based on one or more non-cellular criterion or cellular criterion. The non-cellular criterion can comprise one or more of a global positioning satellite (GPS) information, an application setting, or a motion sensor information. The cellular criterion can comprise one or more of the UE staying on one specific cell during a service duration, or the UE moving with respect to two or more cells. The determination can be made using the ML model.

In another aspect, the processors 402 can be configured to determine, at the UE 106 with the ML model, when the UE 106 is in a fixed route scenario or a normal route scenario based on one or more of non-cellular criterion or cellular criterion. The non-cellular criterion can comprise one or more of a global positioning satellite (GPS) information, or a UE behavior. The cellular criterion can comprise one or more of a current or previous cell match with a recorded cell in an ML model database, or an ML model predicted cell band or frequency match with an actual cell.

In another aspect, the processors 402 can be configured to determine 1822, at the UE 106, when the service-based scenario detected is the stationary service 1826. The processors 402 can determine 1838, at the UE 106, when the stationary service is under one cell coverage or more than one cell coverage. The processors 402 and/or 604 can stop 1842, at the UE 106, the RRM measurement when the stationary service is under one cell coverage. The processors 402 can retrieve 1846, at the UE 106, candidate cell information for candidate cells from ML model results when the UE 106 is under more than one cell coverage. The processors 604 can perform 1850, at the UE 106, the relaxed RRM measurements only for the candidate cells from the ML model results.

In another aspect, the processors 402 can be configured to determine 1822, at the UE 106, when the service-based scenario detected is the fixed route service 1830. The processors 402 can determine 1854, at the UE 106, when a cell is in an ML model database. The processors 402 can retrieve 1858, at the UE 106, from the ML model database a preferred frequency measurement for a specific target cell when the cell is in the ML model database. The processors 402 can determine 1862, at the UE 106, when the preferred target cell is available. The processors 604 can perform 1866, at the UE 106, the relaxed RRM measurement only for the preferred target cell when the preferred target cell is available. In another aspect, the processors 402 can determine 1870, at the UE 106, when a cell meets a fixed route cell when the cell is not in the ML model database. The processors 402 can update 1874, at the UE 106, the ML model database with the cell information when the cell meets the fixed route cell.

In another aspect, the processors 402 can be configured to determine 1822, at the UE 106, when the service-based scenario detected is the normal route service 1834. The processors 402 can determine 1882, at the UE 106, when a current location and a current cell are in an ML model database. The processors 402 can retrieve 1886, at the UE 106, a preferred frequency measurement for a specific target cell when the current location and the current cell are in the ML model database. The processors 402 can determine 1890, at the UE 106, a priority of an inter/intra frequency and inter radio access technology (RAT) measurement by ML model prediction based on a previous cell when the current location and the current cell are not in the ML model database. The processors 604 can perform 1894, at the UE 106, the relaxed RRM measurement with priority based on UE determination and update the ML model database.

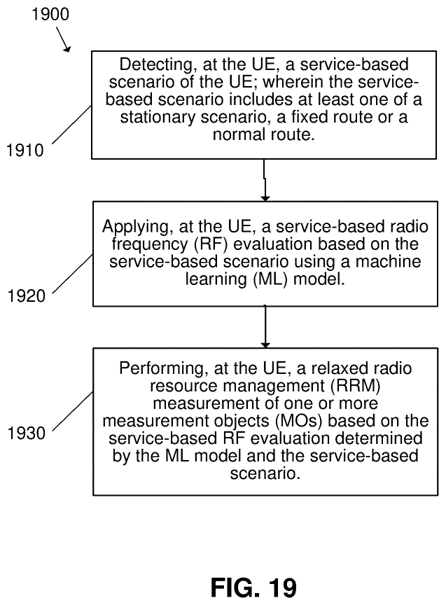

### FIG. 19: Method of Service-Based Dynamic Relaxed RRM Measurement in Idle/Inactive Mode

FIG. 19 illustrates an example flow chart for a method of a relaxed radio resource management (RRM) measurement of an apparatus of a reduced capability (RedCap) user equipment (UE) in a wireless communication system, according to some embodiments.

The method 1900 can comprise detecting 1910, at the UE, a service-based scenario of the UE. The service-based scenario can include at least one of a stationary scenario, a fixed route or a normal route. The method 1900 can comprise applying 1920, at the UE, a service-based radio frequency (RF) evaluation based on the service-based scenario using a machine learning (ML) model. The method 1900 can comprise performing 1930, at the UE, a relaxed radio resource management (RRM) measurement of one or more measurement objects (MOs) based on the service-based RF evaluation determined by the ML model and the service-based scenario.

In another aspect, the method 1900 can further comprise stopping, at the UE, the RRM measurement of the one or more MOs based on the service-based RF evaluation determined by the ML model and the service-based scenario.

In another aspect, the method 1900 can further comprise relaxing dynamically the RRM measurement of the one or more MOs based on the service-based RF evaluation determined by the ML model and the service-based scenario.

In another aspect, the method 1900 can further comprise the UE being in an idle mode or an inactive mode.

In another aspect, the method 1900 can further comprise training, at the UE, the ML model with one or more input factors including one or more of a location metric, a motion metric, an application (APP) behavior, or a cellular metric. The location metric can comprise one or more of a global positioning satellite (GPS) information, a cellular information, or a Wi-Fi information. The motion metric can comprise a high speed or a low speed. The APP behavior can comprise a current active APP or a previous active APP. The cellular metric can comprise a current RF condition or a previous RF condition.

In another aspect, the method 1900 can further comprise obtaining, at the UE, an output from the ML model. The output can comprise one or more of an evaluation result for a service scenario identity, or a prediction of an RRM relaxed behavior.

In another aspect, the method 1900 can further comprise determining, at the UE, when the UE is stationary or mobile. The method 1900 can further comprise stopping the RRM measurement when the UE is stationary.

In another aspect, the method 1900 can further comprise determining, at the UE, when the UE is stationary or mobile based on one or more non-cellular criterion or cellular criterion. The non-cellular criterion can comprise one or more of a global positioning satellite (GPS) information, an application setting, or a motion sensor information. The cellular criterion can comprise one or more of the UE staying on one specific cell during a service duration, or the UE moving with respect to two or more cells.

In another aspect, the method 1900 can further comprise determining, at the UE with the ML model, when the UE is in a fixed route scenario or a normal route scenario based on one or more of non-cellular criterion or cellular criterion. The non-cellular criterion can comprise one or more of a global positioning satellite (GPS) information, or a UE behavior. The cellular criterion can comprise one or more of a current or previous cell match with a recorded cell in an ML model database, or an ML predicted cell band or frequency match with an actual cell.

In another aspect, the method 1900 can further comprise determining 1822, at the UE, when the service-based scenario detected is the stationary service 1826. The method 1900 can further comprise determining 1838, at the UE, when the stationary service is under one cell coverage or more than one cell coverage. The method 1900 can further comprise stopping 1842, at the UE, the RRM measurement when the stationary service is under one cell coverage. The method 1900 can further comprise retrieving 1846, at the UE, candidate cell information for candidate cells from ML model results when the UE is under more than one cell coverage. The method 1900 can further comprise performing 1850, at the UE, the relaxed RRM measurements only for the candidate cells from the ML model results.

In another aspect, the method 1900 can further comprise determining, 1822 at the UE, when the service-based scenario detected is the fixed route service. The method 1900 can further comprise determining 1854, at the UE, when a cell is in an ML model database. The method 1900 can further comprise retrieving 1858, at the UE, from the ML model database a preferred frequency measurement for a specific target cell when the cell is in the ML model database. The method 1900 can further comprise determining 1862, at the UE, when the preferred target cell is available. The method 1900 can further comprise performing 1866, at the UE, the relaxed RRM measurement only for the preferred target cell when the preferred target cell is available. In another aspect, the method 1900 can further comprise determining 1870, at the UE, when a cell meets a fixed route cell when the cell is not in the ML model database. The method 1900 can further comprise updating 1874, at the UE, the ML model database with the cell information when the cell meets the fixed route cell.

In another aspect, the method 1900 can further comprise determining 1822, at the UE, when the service-based scenario detected is the normal route service. The method 1900 can further comprise determining 1882, at the UE, when a current location and a current cell are in an ML model database. The method 1900 can further comprise retrieving 1886, at the UE, a preferred frequency measurement for a specific target cell when the current location and the current cell are in the ML model database. The method 1900 can further comprise determining 1890, at the UE, a priority of an inter/intra frequency and inter radio access technology (RAT) measurement by ML model prediction based on a previous cell when the current location and the current cell are not in the ML model database. The method 1900 can further comprise performing 1894, at the UE, the relaxed RRM measurement with priority based on UE determination and update the ML model database.

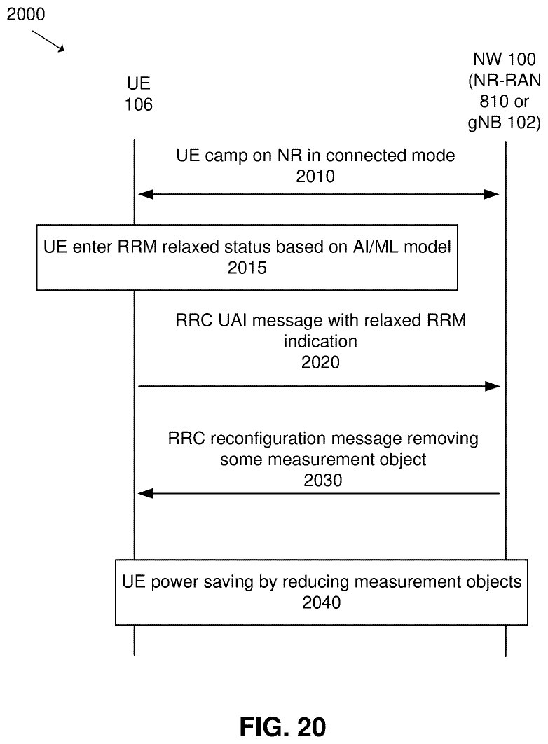

### FIGS. 20 & 21: Service-Based Dynamic Relaxed RRM Measurement in Connected Mode

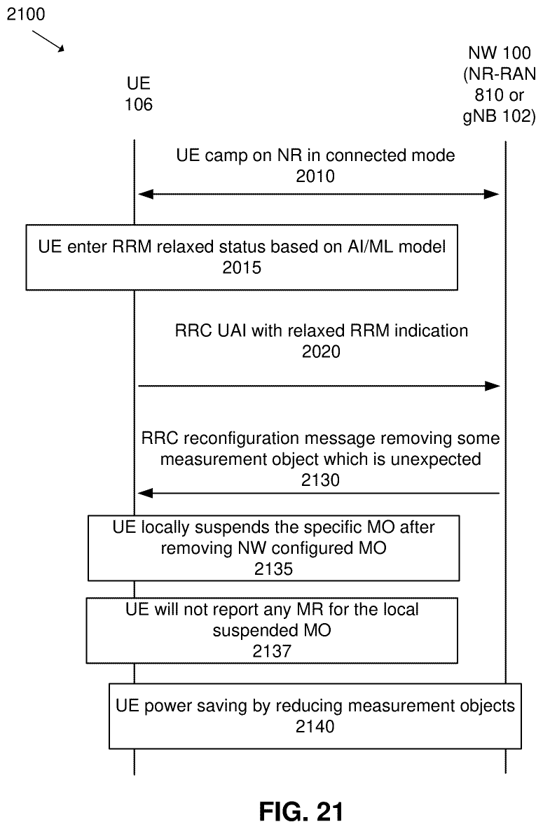

FIGS. 20 and 21 illustrate signaling 2000 and 2100 of a relaxed RRM measurement in a connected mode in a wireless communication system, according to some embodiments. A service-based scenario can be determined by the ML model and the relaxed RRM measurement can be initiated by the UE.

Referring to FIG. 20, the UE 106 can camp on (or select a cell from) a network (NW) 100, e.g. a new radio-radio access network (NR-RAN) 810 or a gNB 102. The UE 106 and the NW 100 (NR-RAN 810 or gNB 102) can exchange one or more messages 2010 regarding system information from the NW 102, registering the presence of the UE 106, and initiating transfer to a connected mode.

The UE 106 can enter an RRM relaxed status 2015 based on the ML model, as described above. The UE 106 can report the relaxed RRM measurement status to the NW 100. The UE 106 can generate a radio resource control (RRC) UE assistance information (UAI) message 2020 for transmission to the NW 100. The UAI message 2020 can indicate the relaxed RRM measurement status in the connected mode.

The NW 100 can generate an RRC reconfiguration message 2030 for transmission to the UE 106. The reconfiguration message 2030 can have some measurement objects (MO) removed or released by the NW 100.

Thus, the UE 106 can save power 2040 by reducing the measurement objects.

In some instances, the NW 100 may remove or release unexpected MOs.

Referring to FIG. 21, the signaling 2100 can be similar to the signaling 2000 described above. The reconfiguration message 2130 can have some measurement objects (MO) removed or released by the NW 100, that are unexpected to be used by the UE 106. The NW configuration of MOs may not be the correct MOs based on the UE ML model results. Thus, the UE 106 can trigger local initiated relaxed status for specific MOs as determined by the ML model, as previously described. The UE 106 can locally suspend the specific MOs after removing the NW configured MOs 2135. The UE 106 may not report any measurement results (MR) for the locally suspended MOs 2137.

Thus, the UE 106 can save power 2140 by reducing the measurement objects.

In one aspect, an apparatus of a reduced capability (RedCap) user equipment (UE) 16 can comprise one or more processors 402 and/or 604 coupled to a memory 406. The processors 604 can be configured to encode and decode (or transmit/generate and receive), at the UE 106, messages 2010 for transmission to and reception from a network (NW) 102. The UE 106 can be in a connected mode with the network 102. The processors 402 can be configured to enter 2015, at the UE 106, a relaxed radio resource management (RRM) status based on a machine learning (ML) model. The processors 604 can encode, at the UE 106, a radio resource control (RRC) UE assistance information (UAI) message 2020 for transmission to the network 102. The RRC UAI message 2020 can include a relaxed RRM indication. The processors 604 can decode, at the UE 106, an RRC reconfiguration message 2130 from the network 102. The RRC reconfiguration message 2130 can have one or more removed measurement objects (MOs).

In one aspect, the processors 402 and/or 604 can be configured to suspend, at the UE 106, a specific MO, The specific MO can be from the RRC reconfiguration message 2130 and can differ from one or more MOs from the ML model. In another aspect, the processors 604 can be configured to encode, at the UE 106, a measurement report (MR) 2137 for transmission to the network 102 without the specific MO.

In another aspect, the processors 402 can be configured to train, at the UE 106, the ML model with one or more input factors including one or more of a location metric, a motion metric, an application (APP) behavior, or a cellular metric.

The processors 402 and/or 604 can be configured to obtain, at the UE 106, an output from the ML model. The output can comprise one or more of an evaluation result for a service scenario identity, or a prediction of an RRM relaxed behavior.

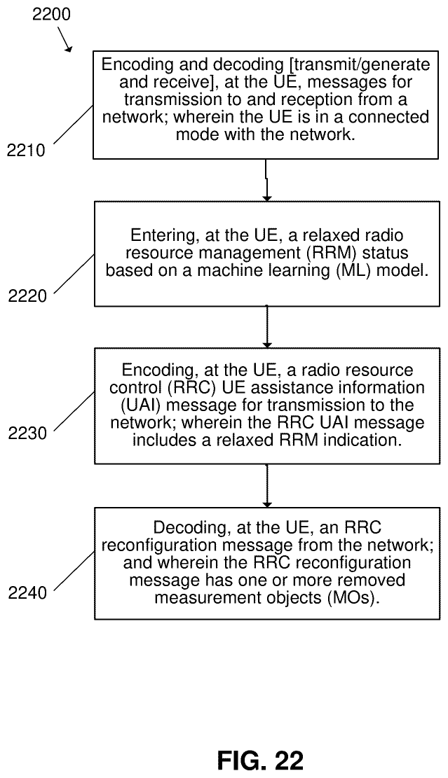

### FIG. 22: Method of Service-Based Dynamic Relaxed RRM Measurement in Connected Mode

FIG. 22 illustrates an example flow chart for a method of a relaxed radio resource management (RRM) measurement of an apparatus of a reduced capability (RedCap) user equipment (UE) in a wireless communication system, according to some embodiments. The UE 106 can be in a connected mode with a network 102.

The method 2200 can comprise encoding and decoding 2210, at the UE 106, messages for transmission to and reception from a network 102. The UE 106 can be in a connected mode with the network 106. The method 2200 can comprise 2220 entering, at the UE 106, a relaxed radio resource management (RRM) status based on a machine learning (ML) model. The method 2200 can comprise encoding 2230, at the UE 106, a radio resource control (RRC) UE assistance information (UAI) message for transmission to the network 102. The RRC UAI message can include a relaxed RRM indication. The method 2200 can comprise decoding 2240, at the UE 106, an RRC reconfiguration message from the network 102. The RRC reconfiguration message can have one or more removed measurement objects (MOs).

In another aspect, the method 2200 can further comprise suspending, at the UE 106, a specific MO. The specific MO can be from the RRC reconfiguration message and can differ from one or more MOs from the ML model. In another aspect, the method 2200 can further comprise encoding, at the UE 106, a measurement report (MR) for transmission to the network 102 without the specific MO.

In one aspect, a baseband processor (e.g. baseband processor 600 or 604), or functionally similar component(s)) whose function may include supporting baseband layer operations (e.g., to facilitate wireless communication between the UE 106 and other wireless devices) in the UE 106, can be configured to cause the UE 106 to perform any of the methods described herein. In another aspect, the UE 106 can have one or more processors (e.g. processors 402 and/or 600 or 604) coupled to a memory 406 to cause the user equipment 106 to perform any of the methods described herein. In another aspect, a baseband processor (e.g. baseband processor 600 or 604 can be configured to cause a base station 102 to perform one or more of the methods described herein. In another aspect, the base station 102 can have one or more processors 204 and/or 600 or 604 coupled to memory 260 configured to cause the base station 102 to perform any of the methods described herein. In another aspect, a computer program product, comprising computer instructions which, when executed by one or more processors, can perform any of the operations described herein.

### EXAMPLES

In the following sections, further exemplary aspects are provided.

According to example 1, an apparatus of a reduced capability (RedCap) user equipment (UE) comprising one or more processors, coupled to a memory, configured to: encode and decode, at the UE, messages for transmission to and reception from a network; wherein the UE is in a connected mode with the network; enter, at the UE, a relaxed radio resource management (RRM) status based on a machine learning (ML) model; encode, at the UE, a radio resource control (RRC) UE assistance information (UAI) message for transmission to the network; wherein the RRC UAI message includes a relaxed RRM indication; and decode, at the UE, an RRC reconfiguration message from the network; and wherein the RRC reconfiguration message has one or more removed measurement objects (MOs).

Example 2 comprises the subject matter of example 1, wherein the one or more processors is further configured to: suspend, at the UE, a specific MO; wherein the specific MO is from the RRC reconfiguration message and differs from one or more MOs from the ML model.

Example 3 comprises the subject matter of example 2, wherein the one or more processors is further configured to: encode, at the UE, a measurement report (MR) for transmission to the network without the specific MO.

Example 4 comprises the subject matter of example 1, wherein the one or more processors are further configured to: train, at the UE, the ML model with one or more input factors including one or more of a location metric, a motion metric, an application (APP) behavior, or a cellular metric; wherein the location metric comprises one or more of a global positioning satellite (GPS) information, a cellular information, or a WiFi information; wherein the motion metric comprises a high speed or a low speed; wherein the APP behavior comprises a current active APP or a previous active APP; and wherein the cellular metric comprises a current RF condition or a previous RF condition.

Example 5 comprises the subject matter of example 1, wherein the one or more processors are further configured to: obtain, at the UE, an output from the ML model; wherein the output comprises one or more of an evaluation result for a service scenario identity, or a prediction of an RRM relaxed behavior.

Example 6 comprises the subject matter of example 1, wherein the one or more processors are further configured to: determine, at the UE, when the UE is stationary or mobile; and stop RRM measurement when the UE is stationary.

Example 7 comprises the subject matter of example 1, wherein the one or more processors are further configured to: determine, at the UE, when the UE is stationary or mobile based on one or more non-cellular criterion or cellular criterion; wherein the non-cellular criterion comprises one or more of a global positioning satellite (GPS) information, an application setting, or a motion sensor information; wherein the cellular criterion comprises one or more of the UE staying on one specific cell during a service duration, or the UE moving with respect to two or more cells.

Example 8 comprises the subject matter of example 1, wherein the one or more processors are further configured to: determine, at the UE with the ML model, when the UE is in a fixed route scenario or a normal route scenario based on one or more of non-cellular criterion or cellular criterion; wherein the non-cellular criterion comprises one or more of a global positioning satellite (GPS) information, or a UE behavior; wherein the cellular criterion comprises one or more of a current or previous cell match with a recorded cell in an ML model database, or an ML predicted cell band or frequency match with an actual cell.

Example 9 comprises the subject matter of example 1, wherein the one or more processors are further configured to: detect, at the UE, a service-based scenario of the UE; wherein the service-based scenario includes at least one of a stationary scenario, a fixed route or a normal route; apply, at the UE, a service-based radio frequency (RF) evaluation based on the service-based scenario using a machine learning (ML) model; and perform, at the UE, a relaxed RRM measurement of one or more measurement objects (MOs) based on the service-based RF evaluation determined by the ML model and the service-based scenario.

Example 10 comprises the subject matter of example 91, wherein the one or more processors are further configured to: determine, at the UE, when the service-based scenario detected is a stationary service; determine, at the UE, when the stationary service is under one cell coverage or more than one cell coverage; stop, at the UE, the RRM measurement when the stationary service is under one cell coverage; retrieve, at the UE, candidate cell information for candidate cells from ML model results when the UE is under more than one cell coverage; and perform, at the UE, the relaxed RRM measurements only for the candidate cells from the ML model results.

Example 11 comprises the subject matter of example 9, wherein the one or more processors are further configured to: determine, at the UE, when the service-based scenario detected is a fixed route service; determine, at the UE, when a cell is in an ML model database; retrieve, at the UE, from the ML model database a preferred frequency measurement for a specific target cell when the cell is in the ML model database; determine, at the UE, when the preferred target cell is available; and perform, at the UE, the relaxed RRM measurement only for the preferred target cell when the preferred target cell is available.

Example 12 comprises the subject matter of example 11, wherein the one or more processors are further configured to: determine, at the UE, when a cell meets a fixed route cell when the cell is not in the ML model database; and update, at the UE, the ML model database with cell information when the cell meets the fixed route cell.

Example 13 comprises the subject matter of example 9, wherein the one or more processors are further configured to: determine, at the UE, when the service-based scenario detected is a normal route service; determine, at the UE, when a current location and a current cell are in an ML model database; retrieve, at the UE, a preferred frequency measurement for a specific target cell when the current location and the current cell are in the ML model database; determine, at the UE, a priority of an inter/intra frequency and inter radio access technology (RAT) measurement by ML model prediction based on a previous cell when the current location and the current cell are not in the ML model database; and perform, at the UE, the relaxed RRM measurement with priority based on UE determination and update the ML model database.

According to example 14, a method of a relaxed radio resource management (RRM) measurement of a reduced capability (RedCap) user equipment (UE) in a wireless communication system, the method comprising: encoding and decoding, at the UE, messages for transmission to and reception from a network; wherein the UE is in a connected mode with the network; entering, at the UE, a relaxed radio resource management (RRM) status based on a machine learning (ML) model; encoding, at the UE, a radio resource control (RRC) UE assistance information (UAI) message for transmission to the network; wherein the RRC UAI message includes a relaxed RRM indication; and decoding, at the UE, an RRC reconfiguration message from the network; and wherein the RRC reconfiguration message has one or more removed measurement objects (MOs).

Example 15 comprises the subject matter of example 14, further comprising: suspending, at the UE, a specific MO; wherein the specific MO is from the RRC reconfiguration message and differs from one or more MOs from the ML model.

Example 16 comprises the subject matter of example 15, further comprising: encoding, at the UE, a measurement report (MR) for transmission to the network without the specific MO.

Example 17 comprises the subject matter of example 14, further comprising: training, at the UE, the ML model with one or more input factors including one or more of a location metric, a motion metric, an application (APP) behavior, or a cellular metric; wherein the location metric comprises one or more of a global positioning satellite (GPS) information, a cellular information, or a WiFi information; wherein the motion metric comprises a high speed or a low speed; wherein the APP behavior comprises a current active APP or a previous active APP; and wherein the cellular metric comprises a current RF condition or a previous RF condition.

Example 18 comprises the subject matter of example 14, further comprising: obtaining, at the UE, an output from the ML model; wherein the output comprises one or more of an evaluation result for a service scenario identity, or a prediction of an RRM relaxed behavior.

Example 19 comprises the subject matter of example 14, further comprising: determining, at the UE, when the UE is stationary or mobile; and stopping the RRM measurement when the UE is stationary.

Example 20 comprises the subject matter of example 14, further comprising: determining, at the UE, when the UE is stationary or mobile based on one or more non-cellular criterion or cellular criterion; wherein the non-cellular criterion comprises one or more of a global positioning satellite (GPS) information, an application setting, or a motion sensor information; wherein the cellular criterion comprises one or more of the UE staying on one specific cell during a service duration, or the UE moving with respect to two or more cells.

Example 21 comprises the subject matter of example 14, further comprising: determining, at the UE with the ML model, when the UE is in a fixed route scenario or a normal route scenario based on one or more of non-cellular criterion or cellular criterion; wherein the non-cellular criterion comprises one or more of a global positioning satellite (GPS) information, or a UE behavior; wherein the cellular criterion comprises one or more of a current or previous cell match with a recorded cell in an ML model database, or an ML predicted cell band or frequency match with an actual cell.

Example 22 comprises the subject matter of example 14, further comprising: detecting, at the UE, a service-based scenario of the UE; wherein the service-based scenario includes at least one of a stationary scenario, a fixed route or a normal route; applying, at the UE, a service-based radio frequency (RF) evaluation based on the service-based scenario using a machine learning (ML) model; and performing, at the UE, a relaxed RRM measurement of one or more measurement objects (MOs) based on the service-based RF evaluation determined by the ML model and the service-based scenario.

Example 23 comprises the subject matter of example 22, further comprising: determining, at the UE, when the service-based scenario detected is a stationary service; determining, at the UE, when the stationary service is under one cell coverage or more than one cell coverage; stopping, at the UE, the RRM measurement when the stationary service is under one cell coverage; retrieving, at the UE, candidate cell information for candidate cells from ML model results when the UE is under more than one cell coverage; and performing, at the UE, the relaxed RRM measurements only for the candidate cells from the ML model results.

Example 24 comprises the subject matter of example 22, further comprising: determining, at the UE, when the service-based scenario detected is a fixed route service; determining, at the UE, when a cell is in an ML model database; retrieving, at the UE, from the ML model database a preferred frequency measurement for a specific target cell when the cell is in the ML model database; determining, at the UE, when the preferred target cell is available; and performing, at the UE, the relaxed RRM measurement only for the preferred target cell when the preferred target cell is available.

Example 25 comprises the subject matter of example 24, further comprising: determining, at the UE, when a cell meets a fixed route cell when the cell is not in the ML model database; and updating, at the UE, the ML model database with cell information when the cell meets the fixed route cell.

Example 26 comprises the subject matter of example 22, further comprising: determining, at the UE, when the service-based scenario detected is a normal route service; determining, at the UE, when a current location and a current cell are in an ML model database; retrieving, at the UE, a preferred frequency measurement for a specific target cell when the current location and the current cell are in the ML model database; determining, at the UE, a priority of an inter/intra frequency and inter radio access technology (RAT) measurement by ML model prediction based on a previous cell when the current location and the current cell are not in the ML model database; and performing, at the UE, the relaxed RRM measurement with priority based on UE determination and update the ML model database.

Another example can comprise a baseband processor configured to cause a user equipment (UE) to perform any of the methods of the preceding examples.

Another example can comprise an apparatus configured to cause a user equipment (UE), having one or more processors coupled to a memory, to perform any of the methods of the preceding examples.

Another example can comprise a computer program product, comprising computer instructions which, when executed by one or more processors, perform any of the operations described herein.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus of a reduced capability (RedCap) user equipment (UE) comprising:
one or more processors, coupled to a memory, configured to:
detect, at the UE, a service-based scenario of the UE;
wherein the service-based scenario includes at least one of a stationary scenario, a fixed route or a normal route;
apply, at the UE, a service-based radio frequency (RF) evaluation based on the service-based scenario using a machine learning (ML) model; and
perform, at the UE, a relaxed radio resource management (RRM) measurement of one or more measurement objects (MOs) based on the service-based RF evaluation determined by the ML model and the service-based scenario.

2. The apparatus of claim 1, wherein the one or more processors are further configured to:
train, at the UE, the ML model with one or more input factors including one or more of a location metric, a motion metric, an application (APP) behavior, or a cellular metric;
wherein the location metric comprises one or more of a global positioning satellite (GPS) information, a cellular information, or a WiFi information;
wherein the motion metric comprises a high speed or a low speed;
wherein the APP behavior comprises a current active APP or a previous active APP; and
wherein the cellular metric comprises a current RF condition or a previous RF condition.

3. The apparatus of claim 1, wherein the one or more processors are further configured to:
obtain, at the UE, an output from the ML model;
wherein the output comprises one or more of an evaluation result for a service scenario identity, or a prediction of an RRM relaxed behavior.

4. The apparatus of claim 1, wherein the one or more processors are further configured to:
determine, at the UE, when the UE is stationary or mobile; and
stop RRM measurement when the UE is stationary.

5. The apparatus of claim 1, wherein the one or more processors are further configured to:
determine, at the UE, when the UE is stationary or mobile based on one or more non-cellular criterion or cellular criterion;
wherein the non-cellular criterion comprises one or more of a global positioning satellite (GPS) information, an application setting, or a motion sensor information;
wherein the cellular criterion comprises one or more of the UE staying on one specific cell during a service duration, or the UE moving with respect to two or more cells.

6. The apparatus of claim 1, wherein the one or more processors are further configured to:
determine, at the UE with the ML model, when the UE is in a fixed route scenario or a normal route scenario based on one or more of non-cellular criterion or cellular criterion;
wherein the non-cellular criterion comprises one or more of a global positioning satellite (GPS) information, or a UE behavior;
wherein the cellular criterion comprises one or more of a current or previous cell match with a recorded cell in an ML model database, or an ML model predicted cell band or frequency match with an actual cell.

7. The apparatus of claim 1, wherein the one or more processors are further configured to:
determine, at the UE, when the service-based scenario detected is a stationary service;
determine, at the UE, when the stationary service is under one cell coverage or more than one cell coverage;
stop, at the UE, the RRM measurement when the stationary service is under one cell coverage;
retrieve, at the UE, candidate cell information for candidate cells from ML model results when the UE is under more than one cell coverage; and
perform, at the UE, the relaxed RRM measurements only for the candidate cells from the ML model results.

8. The apparatus of claim 1, wherein the one or more processors are further configured to:
determine, at the UE, when the service-based scenario detected is a fixed route service;
determine, at the UE, when a cell is in an ML model database;
retrieve, at the UE, from the ML model database a preferred frequency measurement for a specific target cell when the cell is in the ML model database;
determine, at the UE, when the preferred target cell is available; and
perform, at the UE, the relaxed RRM measurement only for the preferred target cell when the preferred target cell is available.

9. The apparatus of claim 8, wherein the one or more processors are further configured to:
determine, at the UE, when a cell meets a fixed route cell when the cell is not in the ML model database; and
update, at the UE, the ML model database with cell information when the cell meets the fixed route cell.

10. The apparatus of claim 1, wherein the one or more processors are further configured to:
determine, at the UE, when the service-based scenario detected is a normal route service;
determine, at the UE, when a current location and a current cell are in an ML model database;
retrieve, at the UE, a preferred frequency measurement for a specific target cell when the current location and the current cell are in the ML model database;
determine, at the UE, a priority of an inter/intra frequency and inter radio access technology (RAT) measurement by ML model prediction based on a previous cell when the current location and the current cell are not in the ML model database; and
perform, at the UE, the relaxed RRM measurement with priority based on UE determination and update the ML model database.

11. A method of a relaxed radio resource management (RRM) measurement of an apparatus of a reduced capability (RedCap) user equipment (UE) in a wireless communication system, the method comprising:
detecting, at the UE, a service-based scenario of the UE;
wherein the service-based scenario includes at least one of a stationary scenario, a fixed route or a normal route;
applying, at the UE, a service-based radio frequency (RF) evaluation based on the service-based scenario using a machine learning (ML) model; and
performing, at the UE, a relaxed radio resource management (RRM) measurement of one or more measurement objects (MOs) based on the service-based RF evaluation determined by the ML model and the service-based scenario.

12. The method of claim 11, further comprising:
training, at the UE, the ML model with one or more input factors including one or more of a location metric, a motion metric, an application (APP) behavior, or a cellular metric;
wherein the location metric comprises one or more of a global positioning satellite (GPS) information, a cellular information, or a WiFi information;
wherein the motion metric comprises a high speed or a low speed;
wherein the APP behavior comprises a current active APP or a previous active APP; and
wherein the cellular metric comprises a current RF condition or a previous RF condition.

13. The method of claim 11, further comprising:
obtaining, at the UE, an output from the ML model;
wherein the output comprises one or more of an evaluation result for a service scenario identity, or a prediction of an RRM relaxed behavior.

14. The method of claim 11, further comprising:
determining, at the UE, when the UE is stationary or mobile; and
stopping the RRM measurement when the UE is stationary.

15. The method of claim 11, further comprising:
determining, at the UE, when the UE is stationary or mobile based on one or more non-cellular criterion or cellular criterion;
wherein the non-cellular criterion comprises one or more of a global positioning satellite (GPS) information, an application setting, or a motion sensor information;
wherein the cellular criterion comprises one or more of the UE staying on one specific cell during a service duration, or the UE moving with respect to two or more cells.

16. The method of claim 11, further comprising:
determining, at the UE with the ML model, when the UE is in a fixed route scenario or a normal route scenario based on one or more of non-cellular criterion or cellular criterion;
wherein the non-cellular criterion comprises one or more of a global positioning satellite (GPS) information, or a UE behavior;
wherein the cellular criterion comprises one or more of a current or previous cell match with a recorded cell in an ML model database, or an ML predicted cell band or frequency match with an actual cell.

17. The method of claim 11, further comprising:
determining, at the UE, when the service-based scenario detected is a stationary service;
determining, at the UE, when the stationary service is under one cell coverage or more than one cell coverage;
stopping, at the UE, the RRM measurement when the stationary service is under one cell coverage;
retrieving, at the UE, candidate cell information for candidate cells from ML model results when the UE is under more than one cell coverage; and
performing, at the UE, the relaxed RRM measurements only for the candidate cells from the ML model results.

18. The method of claim 11, further comprising:
determining, at the UE, when the service-based scenario detected is a fixed route service;
determining, at the UE, when a cell is in an ML model database;
retrieving, at the UE, from the ML model database a preferred frequency measurement for a specific target cell when the cell is in the ML model database;
determining, at the UE, when the preferred target cell is available; and
performing, at the UE, the relaxed RRM measurement only for the preferred target cell when the preferred target cell is available.

19. The method of claim 18, further comprising:
determining, at the UE, when a cell meets a fixed route cell when the cell is not in the ML model database; and
updating, at the UE, the ML model database with cell information when the cell meets the fixed route cell.

20. The method of claim 11, further comprising:
determining, at the UE, when the service-based scenario detected is a normal route service;
determining, at the UE, when a current location and a current cell are in an ML model database;
retrieving, at the UE, a preferred frequency measurement for a specific target cell when the current location and the current cell are in the ML model database;
determining, at the UE, a priority of an inter/intra frequency and inter radio access technology (RAT) measurement by ML model prediction based on a previous cell when the current location and the current cell are not in the ML model database; and
performing, at the UE, the relaxed RRM measurement with priority based on UE determination and update the ML model database.
